(19) United States
(12) Patent Application Publication
(10) Pub. No.: US 2024/0290292 A1
(43) Pub. Date: Aug. 29, 2024

(54) DISPLAY DEVICE

(71) Applicant: Japan Display Inc., Tokyo (JP)

(72) Inventor: Yoshihiro WATANABE, Tokyo (JP)

(73) Assignee: Japan Display Inc., Tokyo (JP)

(21) Appl. No.: 18/581,663

(22) Filed: Feb. 20, 2024

(30) Foreign Application Priority Data
Feb. 24, 2023 (JP) 2023-027250

(51) Int. Cl. G09G 3/36; G02F 1/1335; G02F 1/1343; G02F 1/1362

(52) U.S. Cl. CPC G09G 3/3625; G02F 1/134345; G02F 1/1362; G09G 3/3607; G02F 1/133514; G02F 2201/123; G02F 2201/52; G09G 2300/0452

(57) ABSTRACT

According to an aspect, a display device includes sub-pixels arrayed along a first direction and a second direction and a drive circuit. The sub-pixels constitute sets of sub-pixels in each of which the sub-pixels are arrayed in a matrix with the sub-pixels of a first sub-pixel number arranged along the first direction and the sub-pixels of a second sub-pixel number arranged along the second direction. Each set of sub-pixels corresponds to a set of pixels in which the pixels are arrayed in a matrix with the pixels of a first pixel number arranged along the first direction and the pixels of a second pixel number arranged along the second direction. A value obtained by dividing the second sub-pixel number by the second pixel number is larger than 1 and smaller than 1.5. The drive circuit drives each sub-pixel based on pixel data of the pixels in a predetermined region.

### CROSS-REFERENCE TO RELATED APPLICATION

This application claims the benefit of priority from Japanese Patent Application No. 2023-027250 filed on Feb. 24, 2023, the entire contents of which are incorporated herein by reference.

### BACKGROUND

### 1. Technical Field

What is disclosed herein relates to a display device.

### 2. Description of the Related Art

FIG. 5A in Japanese Patent Application Laid-open Publication No. 2021-189336 (JP-A-2021-189336) discloses a stripe pixel array, which is an example of an array of sub-pixels in a display device. In the stripe pixel array, three rectangular sub-pixels disposed in parallel constitute one pixel.

To achieve higher resolution by reducing the size of the sub-pixel in this stripe pixel array, the width of the sub-pixel in the lateral direction is reduced. As a result, a region for disposing a plurality of signal lines along the lateral direction of the sub-pixel may possibly fail to be secured.

FIG. 5B in JP-A-2021-189336 discloses an SQy pixel array, which is an example of the array of sub-pixels that solves this problem. In the SQy pixel array, a total of six sub-pixels, two in the lateral direction of the rectangular sub-pixel and three in the longitudinal direction of the sub-pixel, constitute two pixels adjacent to each other in the longitudinal direction of the sub-pixel.

The width of the sub-pixel in the lateral direction in the SQy pixel array is large, (3/2) times the width of the sub-pixel in the lateral direction in the stripe pixel array. With this configuration, the region for disposing the signal lines can be secured.

However, the length of the sub-pixel in the longitudinal direction in the SQy pixel array is short, (2/3) times the length of the sub-pixel in the longitudinal direction in the stripe pixel array. In the longitudinal direction of the sub-pixel, the number of sub-pixels in the SQy pixel array is larger than that of sub-pixels in the stripe pixel array. Therefore, the SQy pixel array requires a larger number of scanning lines disposed along the longitudinal direction than the stripe pixel array, and it may possibly be difficult to make what is called a refresh rate (vertical scanning frequency) indicating the frequency of updating images relatively high.

For the foregoing reasons, there is a need for a display device capable of achieving high resolution and a relatively high refresh rate.

### SUMMARY

According to an aspect, a display device includes: a plurality of sub-pixels arrayed in a matrix along a first direction and a second direction orthogonal to each other in a display region for displaying an image; and a drive circuit configured to drive the sub-pixels based on pixel data having information on a plurality of pixels constituting the image. The sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction. The pixels are positioned in a matrix along the first direction and the second direction. Each of the sets of sub-pixels corresponds to a set of pixels in which the pixels are arrayed in a matrix with the pixels of a first pixel number of 2 or larger arranged along the first direction and the pixels of a second pixel number of 2 or larger arranged along the second direction. A value obtained by dividing the second sub-pixel number by the second pixel number is larger than 1 and smaller than 1.5. The drive circuit is configured to drive each of the sub-pixels based on the pixel data of the pixels in a predetermined region.

According to an aspect, a display device includes: a plurality of sub-pixels arrayed in a matrix along a first direction and a second direction inclined with respect to the first direction in a display region for displaying an image; and a drive circuit configured to drive the sub-pixels based on pixel data having information on a plurality of pixels constituting the image. The sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction. The pixels are positioned in a matrix along the second direction and a third direction orthogonal to the second direction. Each of the sets of sub-pixels corresponds to a set of pixels in which the pixels are arrayed in a matrix with the pixels of a first pixel number of 2 or larger arranged along the third direction and the pixels of a second pixel number of 2 or larger arranged along the second direction. A value obtained by dividing the second sub-pixel number by the second pixel number is larger than 1 and smaller than 1.5. The drive circuit is configured to drive each of the sub-pixels based on the pixel data of the pixels in a predetermined region.

According to an aspect, a display device includes: a plurality of sub-pixels arrayed in a matrix along a first direction and a second direction inclined with respect to the first direction in a display region for displaying an image; and a drive circuit configured to drive the sub-pixels based on pixel data having information on a plurality of pixels constituting the image. The sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction. The pixels are positioned in a matrix along the first direction and a third direction orthogonal to the first direction. Each of the sets of sub-pixels corresponds to a set of pixels in which the pixels are arrayed in a matrix with the pixels of a first pixel number of 2 or larger arranged along the first direction and the pixels of a second pixel number of 2 or larger arranged along the third direction. A value obtained by dividing the second sub-pixel number by the second pixel number is larger than 1 and smaller than 1.5. The drive circuit drives the sub-pixels based on the pixel data of the pixels in a predetermined region.

### BRIEF DESCRIPTION OF THE DRAWINGS

FIG. 1 is a schematic of the configuration of a display device according to a first embodiment of the present disclosure;

FIG. 2 is a diagram of a circuit configuration of a display panel;

FIG. 3 is a sectional view of the display panel;

FIG. 4 is a plan view of the display panel;

FIG. 5 is a diagram of a first set of sub-pixels;

FIG. 6 is a diagram of a second set of sub-pixels;

FIG. 7 is a diagram of a third set of sub-pixels;

FIG. 8 is a plan view of the display panel indicating the array of a plurality of sets of sub-pixels in a display region;

FIG. 9 is a diagram of the distance between a sub-pixel and a pixel;

FIG. 10 is a plan view of a set of sub-pixels according to a first modification of the first embodiment;

FIG. 11 is a plan view of the first set of sub-pixels according to a second modification of the first embodiment;

FIG. 12 is a plan view of the first set of sub-pixels according to a third modification of the first embodiment;

FIG. 13 is a plan view of the first set of sub-pixels according to a fourth modification of the first embodiment;

FIG. 14 is a plan view of the first set of sub-pixels according to a fifth modification of the first embodiment;

FIG. 15 is a plan view of the display panel indicating the array of a plurality of sets of sub-pixels according to a second embodiment of the present disclosure;

FIG. 16 is a diagram of the positional relation between a plurality of sets of sub-pixels and a plurality of sets of pixels according to the second embodiment of the present disclosure;

FIG. 17 is a diagram of the circuit configuration of the display panel according to the second embodiment;

FIG. 18 is a plan view of the display panel indicating the array of a plurality of sets of sub-pixels according to a first modification of the second embodiment;

FIG. 19 is a diagram of the positional relation between a plurality of sets of sub-pixels and a plurality of sets of pixels according to a first modification of the second embodiment of the present disclosure;

FIG. 20 is a plan view of the display panel indicating the array of a plurality of sets of sub-pixels according to a second modification of the second embodiment of the present disclosure;

FIG. 21 is a diagram of the positional relation between a plurality of sets of sub-pixels and a plurality of sets of pixels according to the second modification of the second embodiment of the present disclosure;

FIG. 22 is a plan view of the display panel indicating the array of a plurality of sets of sub-pixels according to a third modification of the second embodiment of the present disclosure; and

FIG. 23 is a diagram of the positional relation between a plurality of sets of sub-pixels and a plurality of sets of pixels according to the third modification of the second embodiment of the present disclosure.

### DETAILED DESCRIPTION

Exemplary embodiments of the present disclosure are described below with reference to the accompanying drawings. The contents described in the embodiments below are not intended to limit the present disclosure. Components described below include components easily conceivable by those skilled in the art and components substantially identical therewith. Furthermore, the components described below may be appropriately combined.

What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the figures, components similar to those previously described with reference to previous figures are denoted by the same reference numerals, and detailed explanation thereof may be appropriately omitted.

X- and Y-directions illustrated in the drawings correspond to the directions parallel to the main surface of a substrate included in a display device 1. The +X and −X sides in the X-direction and the +Y and −Y sides in the Y-direction correspond to the sides of the display device 1. A Z-direction corresponds to the thickness direction of the display device 1. The +Z side in the Z-direction corresponds to the front surface side where images are displayed in the display device 1, and the −Z side in the Z-direction corresponds to the back surface side of the display device 1. In the present specification, “plan view” refers to viewing the display device 1 from the +Z side to the −Z side along the Z-direction. The X-, Y-, and Z-directions are given by way of example only and are not intended to limit the present disclosure.

### First Embodiment

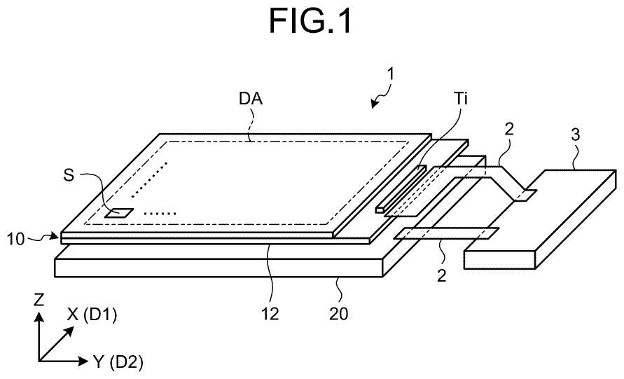

FIG. 1 is a schematic of the configuration of the display device 1 according to a first embodiment of the present disclosure. The display device 1 displays images based on image signals output from an external device 3 electrically coupled via a flexible wiring substrate 2. The display device 1 includes a display panel 10 and a lighting device 20.

The display panel 10 is a transmissive liquid crystal display. The display panel 10 may be an organic EL display or a display made of inorganic luminescent material, for example. The front surface of the display panel 10 has a display region DA where images are displayed. The display panel 10 includes a plurality of sub-pixels S arrayed in a matrix (row-column configuration) along a first direction D1 and a second direction D2 in the display region DA. The first direction D1 is parallel to the X-direction. The second direction D2 is parallel to the Y-direction. In other words, the first direction D1 and the second direction D2 are orthogonal to each other. The sub-pixel S will be described later in greater detail.

The lighting device 20 is disposed on the back surface side of the display panel 10 and outputs light toward the display panel 10. The lighting device 20 is composed of a plurality of light-emitting diodes, for example.

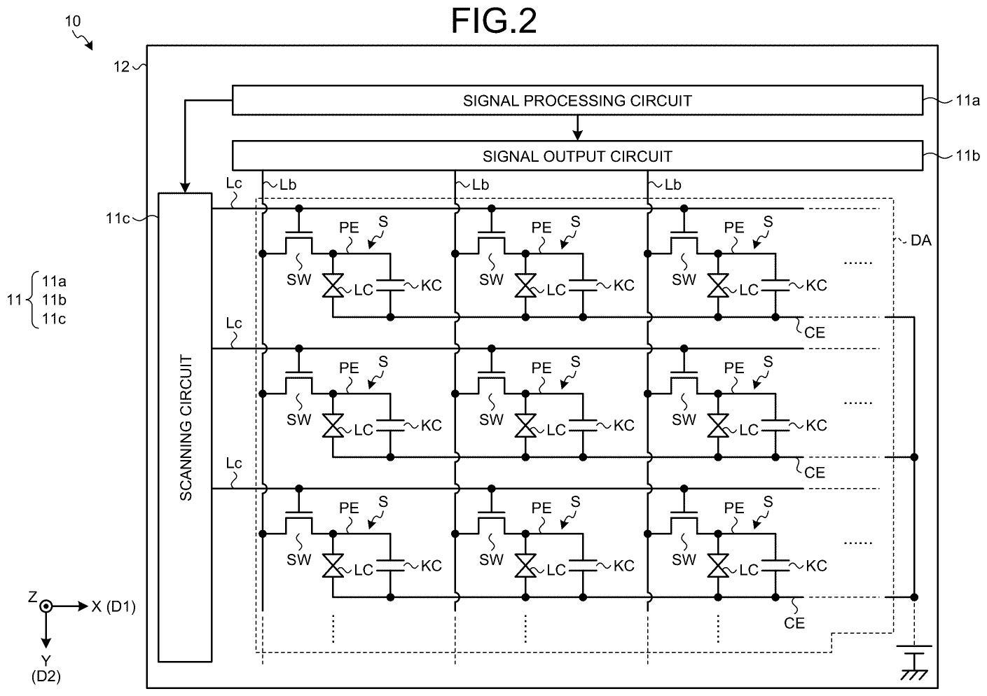

FIG. 2 is a diagram of a circuit configuration of the display panel 10. The display panel 10 includes a drive circuit 11, and a switching element SW, a sub-pixel electrode PE, a common electrode CE, liquid crystal capacitance LC, and holding capacitance KC that are included in each of the sub-pixels S.

The drive circuit 11 drives a plurality of sub-pixels S. The drive circuit 11 includes a signal processing circuit 11a, a signal output circuit 11b, and a scanning circuit 11c.

The signal processing circuit 11a generates a plurality of sub-pixel signals (which will be described later in detail) based on the image signals transmitted from the external device 3 and outputs the generated sub-pixel signals to the signal output circuit 11b. The signal processing circuit 11a outputs clock signals for synchronizing the operation of the signal output circuit 11b with the operation of the scanning circuit 11c to the signal output circuit 11b and the scanning circuit 11c.

The signal output circuit 11b outputs the sub-pixel signals to the respective sub-pixels S. The signal output circuit 11b and the sub-pixels S are electrically coupled via a plurality of signal lines Lb extending along the second direction D2.

The scanning circuit 11c scans a plurality of sub-pixels S in synchronization with the output of the sub-pixel signals by the signal output circuit 11b. The scanning circuit 11c and the sub-pixels S are electrically coupled via a plurality of scanning lines Lc extending along the first direction D1.

The switching element SW is composed of a thin-film transistor (TFT), for example. In the switching element SW, the source electrode is electrically coupled to the signal line Lb, and the gate electrode is electrically coupled to the scanning line Lc.

The sub-pixel electrode PE is coupled to the drain electrode of the switching element SW. A plurality of common electrodes CE are disposed corresponding to the scanning lines Lc. The sub-pixel electrode PE and the common electrode CE have light-transmitting properties.

The liquid crystal capacitance LC is a capacitance component of the liquid crystal material of a liquid crystal layer 13, which will be described later, between the sub-pixel electrode PE and the common electrode CE. The holding capacitance KC is provided between the electrode with the same potential as the common electrode CE and the electrode with the same potential as the sub-pixel electrode PE.

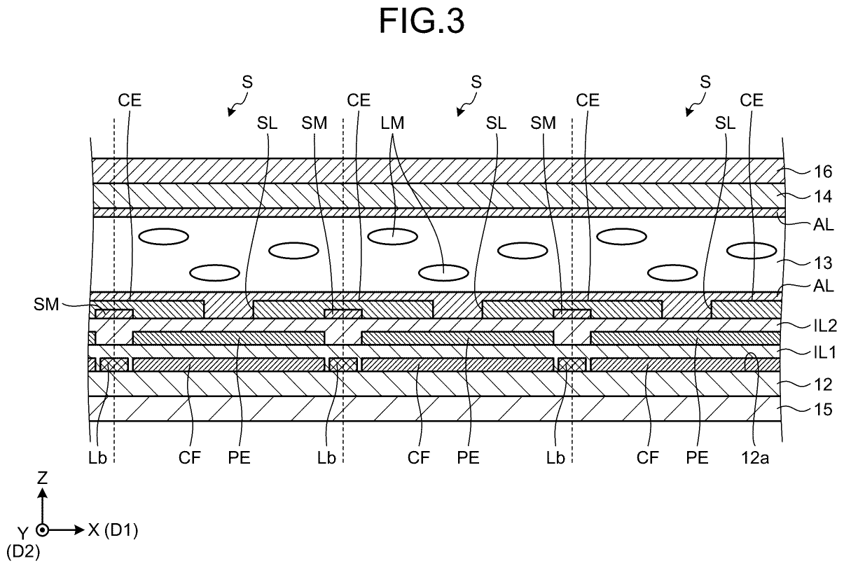

FIG. 3 is a sectional view of the display panel 10. The sub-pixel S further includes a first substrate 12, the liquid crystal layer 13, and a second substrate 14. The first substrate 12, the liquid crystal layer 13, and the second substrate 14 have light transmitting properties and are disposed in this order from the −Z side to the +Z side along the Z-direction.

The first substrate 12 has a rectangular shape in plan view, and the one first substrate 12 is provided for the sub-pixels S. The first substrate 12 is provided with an IC chip Ti constituting the drive circuit 11 (refer to FIG. 1).

Color filters CF and the signal lines Lb are disposed on a main surface 12a on the +Z side of the first substrate 12. The color filters CF each have a rectangular shape in plan view and are disposed corresponding to the sub-pixels S.

The color filter CF has a light transmitting property, and the peak of the spectrum of light to be transmitted through the color filter CF is determined in advance. The peak of the spectrum is one of the peaks of three spectra corresponding to three different colors. While the three colors are red, green, and blue, it is needless to say that the number and type of colors are not limited thereto. In the following description, the color corresponding to the peak of the spectrum of light transmitted by the color filter CF is referred to as the color of the color filter CF.

The signal line Lb is disposed between the color filters CF of two sub-pixels S adjacent to each other in the first direction D1. The signal line Lb is provided at a position overlapping the boundary of two sub-pixels S adjacent to each other in the first direction D1. On the main surface 12a, the scanning line Lc (not illustrated in FIG. 3) is disposed between the color filters CF of two sub-pixels S adjacent to each other in the second direction D2.

The first substrate 12 is also provided with the sub-pixel electrodes PE on the +Z side of the color filters CF and the signal lines Lb with an insulating layer IL1 interposed therebetween. The sub-pixel electrode PE overlaps the color filter CF in the Z-direction.

The first substrate 12 is also provided with a light-shielding film SM and the common electrodes CE on the +Z side of the sub-pixel electrodes PE with an insulating layer IL2 interposed therebetween.

The light-shielding film SM has a light-blocking property and partitions a plurality of sub-pixels S. In other words, the light-shielding film SM is provided at positions overlapping the boundaries of the sub-pixels S adjacent to each other in the first direction D1 and the sub-pixels S adjacent to each other in the second direction D2. The light-shielding film SM overlaps the signal lines Lb and the scanning lines Lc in the Z-direction.

The common electrode CE is stacked on the +Z side of the light-shielding film SM, has slits SL, and is disposed over two sub-pixel electrodes PE adjacent to each other. Thus, the common electrode CE and the sub-pixel electrodes PE are disposed on the first substrate 12. In other words, the display panel 10 is a lateral electric field liquid crystal display.

The liquid crystal layer 13 includes a plurality of liquid crystal molecules LM. The liquid crystal layer 13 is provided between two orientation films AL facing each other in the Z-direction. The orientation of the liquid crystal molecules LM is regulated by the two orientation films AL.

The second substrate 14 has a rectangular shape in plan view, and the one second substrate 14 is provided for the sub-pixels S.

The display panel 10 further includes a first polarizing plate 15 disposed on the back surface side of the first substrate 12 and a second polarizing plate 16 disposed on the front surface side of the second substrate 14.

The first polarizing plate 15 has a transmission axis orthogonal to the Z-direction. The second polarizing plate 16 has a transmission axis orthogonal to the transmission axis of the first polarizing plate 15 and the Z-direction.

The following describes the operation of the display panel 10. First, a case is described where the display panel 10 is a normally black system, and black color is displayed in the display region DA. In this case, the drive circuit 11 does not drive the sub-pixels S, and no electric field is generated in the liquid crystal layer 13. Therefore, the orientation of the liquid crystal molecules LM is regulated by the orientation films AL.

Light from the lighting device 20 enters the first polarizing plate 15 from the back surface side of the display panel 10. The light transmitted through the first polarizing plate 15 is linearly polarized light with a polarization axis parallel to the transmission axis of the first polarizing plate 15. The light transmitted through the first polarizing plate 15 passes through the first substrate 12 and enters the liquid crystal layer 13.

When the orientation of the liquid crystal molecules LM is regulated by the orientation films AL, the polarization axis of the light transmitted through the liquid crystal layer 13 is not rotated. The light transmitted through the liquid crystal layer 13 passes through the second substrate 14 and enters the second polarizing plate 16.

The polarization axis of the light transmitted through the liquid crystal layer 13 and the second substrate 14 is orthogonal to the transmission axis of the second polarizing plate 16. The light transmitted through the liquid crystal layer 13 does not pass through the second polarizing plate 16. In other words, when the orientation of the liquid crystal molecules LM is regulated by the orientation films AL, the light output from the lighting device 20 does not pass through the sub-pixels S. As a result, the display region DA displays black.

Next, the operation of the display panel 10 when an image is displayed in the display region DA is described. In this case, the sub-pixel signals generated by the signal processing circuit 11a are output to the sub-pixels S via the signal output circuit 11b. The sub-pixel signal includes sub-gradation data indicating the gradation of the sub-pixel S, which will be described later.

When the sub-pixel S is scanned by the scanning circuit 11c, the switching element SW is operated, and the sub-pixel signal is transmitted to the sub-pixel electrode PE. This generates a potential difference between the common electrode CE and the sub-pixel electrode PE to generate an electric field in the liquid crystal layer 13, thereby changing the orientation of the liquid crystal molecules LM. The orientation of the liquid crystal molecules LM is the orientation corresponding to the sub-gradation data. In other words, in the liquid crystal layer 13, the direction of the polarization axis of light changes depending on the sub-gradation data. In the light transmitted through the liquid crystal layer 13, light the polarization axis of which is not orthogonal to the polarization axis of the second polarizing plate 16 passes through the second polarizing plate 16.

The luminance of the light transmitted through the second polarizing plate 16 is the luminance corresponding to the sub-gradation data. Thus, the orientation of the liquid crystal molecules LM is adjusted by the sub-pixel signals, thereby adjusting the transmittance of the liquid crystal layer 13 and the luminance of light passing through the liquid crystal layer 13. The light transmitted through the color filter CF in the first substrate 12 has a color corresponding to the color of the color filter CF. In other words, the light transmitted through the second polarizing plate 16 has a color corresponding to the color of the color filter CF and adjusted luminance.

In each of the sub-pixels S, the color of the color filter CF, that is, the color of the light passing through the second polarizing plate 16 corresponds to the color of the sub-pixel S. In each of the sub-pixels S, the luminance of the light passing through the second polarizing plate 16 is adjusted based on the sub-gradation data. As a result, an image based on the image signals is displayed in the display region DA. The display panel 10 may be a normally white system.

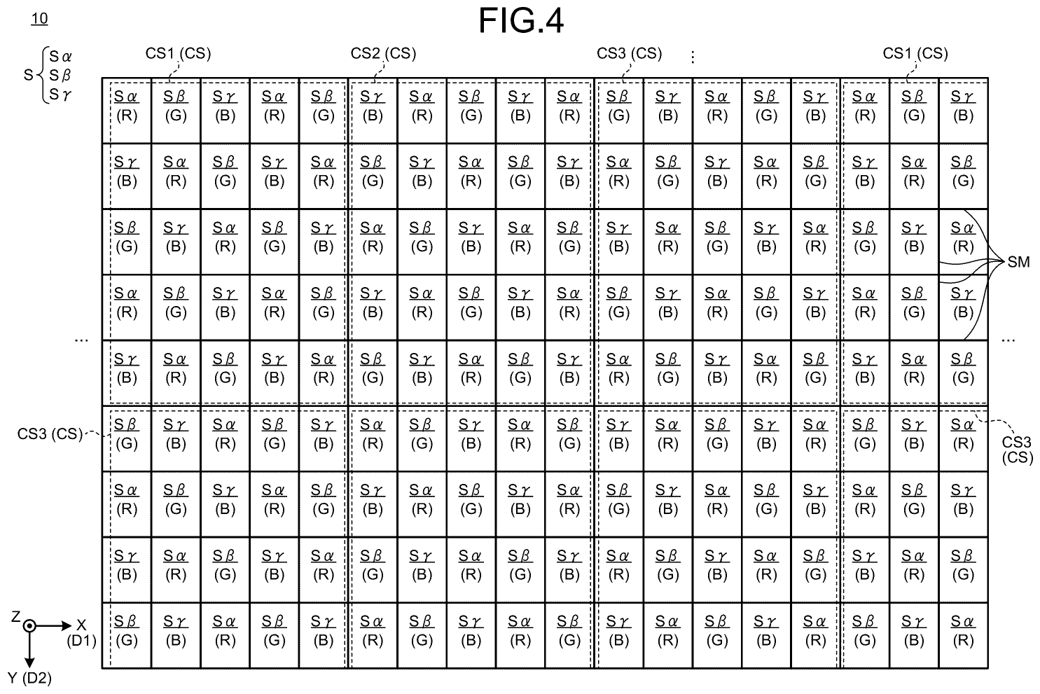

Next, the array of the sub-pixels S in the display region DA is described with reference to FIG. 4. FIG. 4 is a plan view of the display panel 10 indicating the array of the sub-pixels S. The sub-pixels S illustrated in FIG. 4 are indicated by the color filters CF and the light-shielding film SM. In plan view, the sub-pixels S are partitioned by the light-shielding film SM, and the color filter CF has a rectangular shape.

The sub-pixels S have the same rectangular shape in plan view. Specifically, the sub-pixels S each have two sides parallel to the first direction D1 and two sides parallel to the second direction D2. The sub-pixels S each have a rectangular shape in plan view with the length in the second direction D2 longer than the length in the first direction D1. The sub-pixels S are disposed in a matrix (row-column configuration) along the first direction D1 and the second direction D2 in the display region DA.

In the sub-pixels S arrayed in a matrix (row-column configuration) in the display region DA, the column number of the sub-pixel S positioned on the most −X side is defined as 1, and the column number increases toward the +X side. In the sub-pixels S arrayed in a matrix (row-column configuration) in the display region DA, the row number of the sub-pixel S positioned on the most −Y side is defined as 1, and the row number increase toward the +Y side.

The sub-pixels S include a plurality of first sub-pixels Sa, a plurality of second sub-pixels SB, and a plurality of third sub-pixels Sγ. The first sub-pixel Sα, the second sub-pixel SB, and the third sub-pixel Sγ have different colors of the color filters CF, that is, different colors of the sub-pixels S. The color of the first sub-pixel Sa is red. The color of the second sub-pixel SB is green. The color of the third sub-pixel Sγ is blue. In other words, the first sub-pixel Sa is a red sub-pixel S. The second sub-pixel SB is a green sub-pixel S. The third sub-pixel Sγ is a blue sub-pixel S. It is needless to say that the colors of the sub-pixels S are not limited thereto, and the color of the first sub-pixel Sα, the color of the second sub-pixel SB, and the color of the third sub-pixel Sγ simply need to be different from each other. In FIG. 4, the reference numeral in parentheses indicates the color of the sub-pixel S. “R” is red, “G” is green, and “B” is blue. The first sub-pixel Sα, the second sub-pixel Sβ, and the third sub-pixel Sγ may be referred to simply as the “sub-pixel S” when common matters are described without distinguishing them.

The first sub-pixels Sα, the second sub-pixels SB, and the third sub-pixels Sγ are arrayed in the arrangement illustrated in FIG. 4. The array of the sub-pixels S illustrated in FIG. 4 is referred to as an SQy1 array. Specifically, in the SQy1 array, the first sub-pixel Sα, the second sub-pixel Sβ, and the third sub-pixel Sγ are repeatedly disposed in this order along the first direction D1 in plan view; and the first sub-pixel Sα, the third sub-pixel Sγ, and the second sub-pixel SB are repeatedly disposed in this order along the second direction D2.

The sub-pixels S include three (three types) sets of sub-pixels CS. The three sets of sub-pixels CS are each composed of sub-pixels S arrayed in a matrix (row-column configuration) with a first sub-pixel number of sub-pixels S arranged along the first direction D1 and a second sub-pixel number of sub-pixels S arranged along the second direction D2. The first sub-pixel number and the second sub-pixel number are natural numbers of 2 or larger. Specifically, the first sub-pixel number is 5, and the second sub-pixel number is 5. In other words, a set of sub-pixels CS is formed of sub-pixels arranged in a matrix (row-column configuration) with the number of rows corresponding to the second sub-pixel number (5) and the number of columns corresponding to the first sub-pixel number (5).

FIG. 4 illustrates a first set of sub-pixels CS1, a second set of sub-pixels CS2, and a third set of sub-pixels CS3.

The first sets of sub-pixels CS1, the second set of sub-pixels CS2, and the third set of sub-pixels CS3 may be referred to simply as a set of sub-pixels CS when they are not distinguished from one another. In a set of sub-pixels CS, the column number of the sub-pixel S positioned on the most −X side is defined as 1, and the column number increases toward the +X side. In a set of sub-pixels CS, the row number of the sub-pixel S positioned on the most −Y side is defined as 1, and the row number increases toward the +Y side.

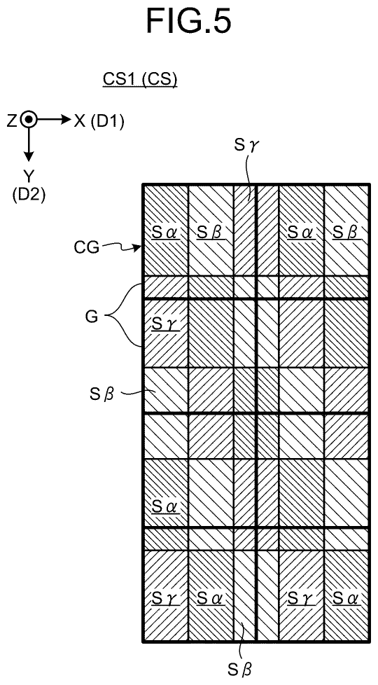

FIG. 5 is a diagram of the first set of sub-pixels CS1. The first set of sub-pixels CS1 is composed of sub-pixels S arrayed in a matrix (row-column configuration) with five sub-pixels S arranged along the first direction D1 and five sub-pixels S arranged along the second direction D2. In the first set of sub-pixels CS1, the sub-pixel S with a row number of 1 and a column number of 1 is the first sub-pixel Sα; and the first sub-pixel Sα, the second sub-pixel Sβ, and third sub-pixel Sγ are disposed in the SQy1 array described above.

The thick lines in FIG. 5 indicate a plurality of pixels G corresponding to the image signals output from the external device 3. A plurality of pixels G constitute an image displayed in the display region DA and are arrayed in a matrix (row-column configuration) along the X- and Y-directions orthogonal to each other in the display region DA. In the first embodiment, the directions in which the pixels G are arrayed are the same as the directions in which the sub-pixels S are arrayed. The pixel G has a square shape in plan view.

A set of sub-pixels CS corresponds to a set of pixels CG in which the sub-pixels S are arrayed in a matrix (row-column configuration) with a first pixel number of pixels G arranged along the X-direction and a second pixel number of pixels G arranged along the Y-direction. In other words, a set of pixels CG is a matrix (row-column configuration) with the number of rows corresponding to the second pixel number and the number of columns corresponding to the first pixel number. In the first embodiment, the periphery of a set of sub-pixels CS and the periphery of a set of pixels CG each have a rectangular shape and overlap each other.

The first pixel number and the second pixel number are natural numbers of 2 or larger. The second sub-pixel number and the second pixel number are defined such that the value obtained by dividing the second sub-pixel number by the second pixel number is larger than 1 and smaller than 1.5. Specifically, the second pixel number is 4, and the value obtained by dividing the second sub-pixel number (5) by the second pixel number (4) is 1.25 (=5/4).

With this configuration, the SQy1 array according to the first embodiment has advantageous effects compared with the SQy pixel array and the stripe pixel array for comparison as described below in detail. In other words, in the SQy pixel array for comparison, a set of sub-pixels in which two sub-pixels S are arranged along the first direction D1 and three sub-pixels S are arranged along the second direction D2 corresponds to a set of pixels in which two pixels G adjacent to each other are arranged in the second direction D2. The value obtained by dividing the second sub-pixel number (3) by the second pixel number (2) is 1.5. Therefore, the length of the sub-pixel S in the second direction D2 in the SQy1 array according to the first embodiment is longer than that in the SQy pixel array for comparison. As a result, the SQy1 array requires a smaller number of scanning lines Lc and can suppress an increase in image rewriting time. In the stripe pixel array for comparison, a set of sub-pixels in which three sub-pixels S are arranged along the first direction D1 corresponds to a set of pixels composed of one pixel G. The value obtained by dividing the second sub-pixel number (1) by the second pixel number (1) is 1. Therefore, the length of the sub-pixel S in the second direction D2 in the SQy1 array according to the first embodiment is smaller than that in the stripe pixel array for comparison. As a result, the SQy1 array can achieve high resolution of an image.

Thus, the SQy1 array according to the first embodiment can suppress an increase in image rewriting time compared with the SQy pixel array for comparison and achieve high resolution of an image compared with the stripe pixel array. In other words, the display device 1 can achieve high resolution and a relatively high refresh rate.

The first sub-pixel number and the first pixel number are defined such that the value obtained by dividing the first sub-pixel number by the first pixel number is larger than 2 and smaller than 3. Specifically, the first pixel number is 2, and the value obtained by dividing the first sub-pixel number (5) by the first pixel number (2) is 2.5 (=5/2).

Therefore, the length of the sub-pixel S in the first direction D1 in the SQy1 array according to the first embodiment is longer than that in the stripe pixel array for comparison in which the value obtained by dividing the first sub-pixel number (3) by the first pixel number (1) is 3. Therefore, compared with the stripe pixel array for comparison, the SQy1 array according to the first embodiment can secure the region for disposing the signal lines Lb arrayed along the first direction D1 and reduce the size of the sub-pixel S to achieve high resolution of an image.

The image signal includes color data and gradation data indicating the information on a plurality of pixels G. The color data includes first color data, second color data, and third color data having different colors. The color of the first color data is the same as that of the first sub-pixel Sα. The color of the second color data is the same as that of the second sub-pixel SR. The color of the third color data is the same as that of the third sub-pixel Sγ. In other words, the information on the pixels G includes three pieces of color data the colors of which are different from each other.

The gradation data includes first color data, that is, first gradation data corresponding to the first sub-pixel Sa, second color data, that is, second gradation data corresponding to the second sub-pixel Sβ, and third color data, that is, third gradation data corresponding to the third sub-pixel Sγ. In other words, the pixels G each have three pieces of gradation data corresponding to the three pieces of color data. The color data and the gradation data correspond to “pixel data”. The first gradation data, the second gradation data, and the third gradation data correspond to “first pixel data,” “second pixel data,” and “third pixel data,” respectively.

The first sub-pixel number, the second sub-pixel number, the first pixel number, and the second pixel number are defined such that the ratio of a first total number to a second total number is 0.9 to 1.1. The first total number is the total of the numbers of the first gradation data, the second gradation data, and the third gradation data of the pixels G constituting a set of pixels CG (hereinafter referred to as the total number of the gradation data). The second total number is the total of the numbers of the first sub-pixels Sα, the second sub-pixels SB, and the third sub-pixels Sγ included in a set of sub-pixels CS (hereinafter referred to as the total number of the sub-pixels S).

Specifically, the total of the numbers of the first sub-pixels Sα, the second sub-pixels SB, and the third sub-pixels Sγ included in a set of sub-pixels CS is 25 (=5×5), which is a value obtained by multiplying the first sub-pixel number (5) by the second sub-pixel number (5). By contrast, the total of the numbers of the first gradation data, the second gradation data, and the third gradation data of the pixels G constituting a set of pixels CG is 24 (=2×4×3), which is a value obtained by multiplying the first pixel number (2), the second pixel number (4), and the number of gradation data (3) included in the information on one pixel G together. Therefore, the ratio of the total number of the gradation data to the total number of the sub-pixels S is 1.04 (=25/24), which is 0.9 to 1.1.

Thus, the difference between the total of the numbers of the sub-pixels S in a set of sub-pixels CS and the total of the numbers of the gradation data in a set of pixels CG can be reduced. Therefore, this configuration can suppress insufficient resolution that would be caused by the total of the numbers of the sub-pixels S being relatively small with respect to the total of the numbers of the pieces of gradation data included in the image signal. This configuration can also prevent the total of the numbers of the sub-pixels S from being relatively large with respect to the total of the numbers of the pieces of gradation data included in the image signal, thus preventing the size of the sub-pixels S from being significantly small. Therefore, this configuration can suppress deterioration in display quality that would be caused by reduction in image contrast due to reduced light-transmittance of the sub-pixels S.

In a set of pixels CG, the column number of the pixel G positioned on the most −X side is defined as 1, and the column number increases toward the +X side. In a set of pixels CG, the row number of the pixel G positioned on the most −Y side is defined as 1, and the row number increases toward the +Y side.

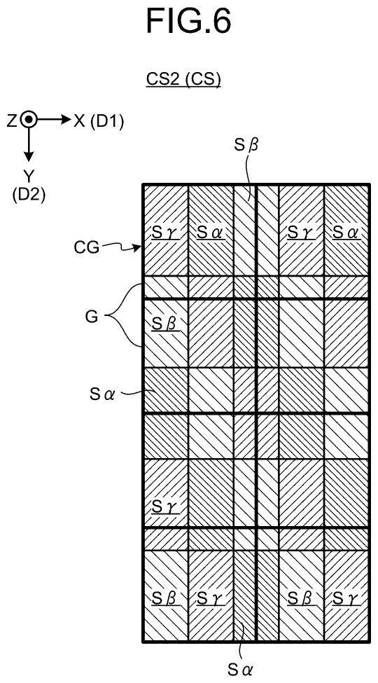

FIG. 6 is a diagram of a second set of sub-pixels CS2. The second set of sub-pixels CS2 is different from the first set of sub-pixels CS1 only in the arrangement of the sub-pixels S. Specifically, in the second set of sub-pixels CS2, the first sub-pixel Sa in the first set of sub-pixels CS1 described above is replaced by the third sub-pixel Sγ, the second sub-pixel SB in the first set of sub-pixels CS1 is replaced by the first sub-pixel Sα, and the third sub-pixel Sγ in the first set of sub-pixels CS1 is replaced by the second sub-pixel Sβ.

In other words, the second set of sub-pixels CS2 is composed of sub-pixels S arrayed in a matrix (row-column configuration) with five sub-pixels S arranged along the first direction D1 and five sub-pixels S arranged along the second direction D2. In the second set of sub-pixels CS2, the sub-pixel S with a row number of 1 and a column number of 1 is the third sub-pixel Sγ; and the first sub-pixel Sα, the second sub-pixel Sβ, and the third sub-pixel Sγ are disposed in the SQy1 array described above. The second set of sub-pixels CS2 corresponds to a set of pixels CG in which pixels G are arrayed in a matrix (row-column configuration) with the first pixel number (2) of pixels G arranged along the first direction D1 and the second pixel number (4) of pixels G arranged along the second direction D2.

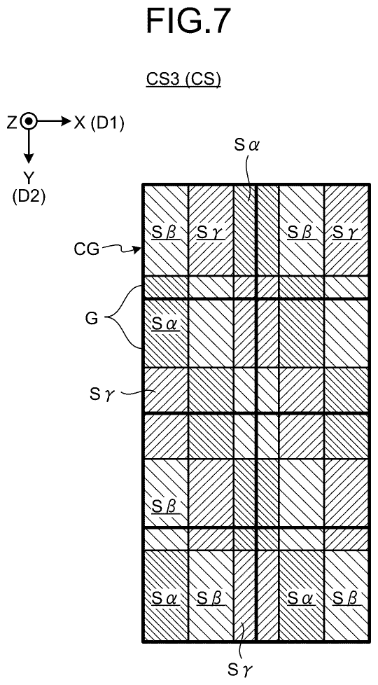

FIG. 7 is a diagram of a third set of sub-pixels CS3. The third set of sub-pixels CS3 is different from the first set of sub-pixels CS1 only in the arrangement of the sub-pixels S. Specifically, in the third set of sub-pixels CS3, the first sub-pixel Sa in the first set of sub-pixels CS1 described above is replaced by the second sub-pixel Sβ, the second sub-pixel SB in the first set of sub-pixels CS1 is replaced by the third sub-pixel Sγ, and the third sub-pixel Sγ in the first set of sub-pixels CS1 is replaced by the first sub-pixel Sα.

In other words, the third set of sub-pixels CS3 is composed of sub-pixels S arrayed in a matrix (row-column configuration) with five sub-pixels S arranged along the first direction D1 and five sub-pixels S arranged along the second direction D2. In the third set of sub-pixels CS3, the sub-pixel S with a row number of 1 and a column number of 1 is the second sub-pixel Sβ; and the first sub-pixel Sα, the second sub-pixel Sβ, and the third sub-pixel Sγ are disposed in the SQy1 array described above. The third set of sub-pixels CS3 corresponds to a set of pixels CG in which pixels G are arrayed in a matrix (row-column configuration) with the first pixel number (2) of pixels G arranged along the first direction D1 and the second pixel number (4) of pixels G arranged along the second direction D2.

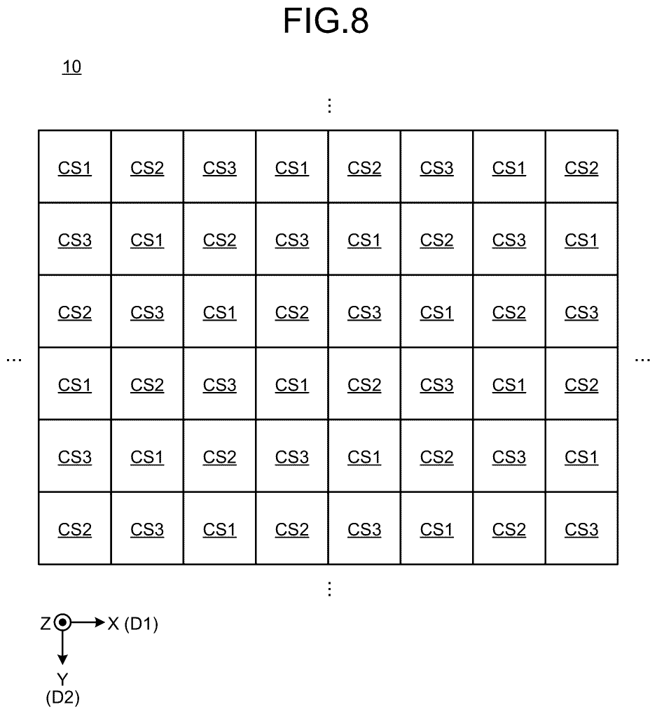

FIG. 8 is a plan view of the display panel 10 indicating the array of a plurality of sets of sub-pixels CS in the display region DA. By disposing the sub-pixels S in the SQy1 array described above, a plurality of sets of sub-pixels CS are disposed as follows: the first set of sub-pixels CS1, the second set of sub-pixels CS2, and the third set of sub-pixels CS3 are repeatedly disposed in this order along the first direction D1; and the first set of sub-pixels CS1, the third set of sub-pixels CS3, and the second set of sub-pixels CS2 are repeatedly disposed in this order along the second direction D2. Thus, the sets of sub-pixels CS are arrayed in a matrix (row-column configuration) along the first direction D1 and the second direction D2.

In the sets of sub-pixels CS arrayed in a matrix (row-column configuration) in the display region DA, the column number of the set of sub-pixels CS positioned on the most −X side is defined as 1, and the column number increases toward the +X side. In the sets of sub-pixels CS arrayed in a matrix (row-column configuration) in the display region DA, the row number of the set of sub-pixels CS positioned on the most −Y side is defined as 1, and the row number increases toward the +Y side.

The three sets of sub-pixels CS1, CS2, and CS3 each correspond to a set of pixels CG. As described above, a plurality of pixels G are disposed in a matrix (row-column configuration) along the X- and Y-directions in the display region DA. Therefore, the pixels G according to the first embodiment are partitioned by the three sets of sub-pixels CS in the display region DA.

In the pixels G arrayed in a matrix (row-column configuration) in the display region DA, the column number of the pixel G positioned on the most −X side is defined as 1, and the column number increases toward the +X side. In the pixels G arrayed in a matrix (row-column configuration) in the display region DA, the row number of the pixel G positioned on the most −Y side is defined as 1, and the row number increases toward the +Y side.

In the following description, the row number and the column number of the sub-pixels S, the pixels G, and the sets of sub-pixels CS arrayed in a matrix (row-column configuration) in the display region DA are referred to as a display row number and a display column number, respectively. The row number and the column number of the sub-pixels S and the pixels G arrayed in a matrix (row-column configuration) in a set of sub-pixels CS and a set of pixels CG are referred to as a set row number and a set column number, respectively.

The following describes the processing of generating the sub-pixel signals by the drive circuit 11 based on the image signals. As described above, the image signal transmitted to the drive circuit 11 includes the color data and the gradation data indicating the information on a plurality of pixels G.

The drive circuit 11 performs rendering to generate the sub-gradation data described above indicating the gradation of the sub-pixel S for each of the sub-pixels S from the gradation data of the pixels G. First, a case is described where the drive circuit 11 generates the sub-gradation data for each of the sub-pixels S using the following Expressions (1) to (8).

$${P}_{r} = {\sum }_{s = {i}_{p}}^{{i}_{p} + 1} {\sum }_{q = {i}_{p}}^{{j}_{p} + 1} {C}_{s , q} \frac{S ( {L}_{s , q} )}{{k}_{a}} \qquad ( 1 )$$

In Expression (1), “Pᵣ” is the sub-gradation data of the sub-pixel S with a display column number “u” and a display row number “v” out of the sub-pixels S arrayed in a matrix (row-column configuration) in the display region DA.

In Expression (1), “iₚ” corresponds to the display column number of the pixel G used to calculate “Pᵣ” and is calculated by Expression (2). “jₚ” corresponds to the display row number of the pixel G used to calculate “Pᵣ” and is calculated by Expression (3).

$${i}_{p} = floor ( {x}_{p} + 0.5 ) \qquad ( 2 )$$

$${j}_{p} = floor ( {y}_{p} + 0.5 ) \qquad ( 3 )$$

In Expressions (2) and (3), the function “floor(α)” derives the largest integer that does not exceed “α”. “xₚ” is the X-coordinate of the sub-pixel S corresponding to “Pᵣ” and is calculated by Expression (4). “yₚ” is the Y-coordinate of the sub-pixel S corresponding to “Pᵣ” and is calculated by Expression (5). The X- and Y-coordinates of the sub-pixel S are the X- and Y-coordinates of the area centroid of the sub-pixel S. The length of one side of the pixel G is “1”.

$${x}_{p} = \frac{u - 0.5}{{k}_{x}} \qquad ( 4 )$$

$${y}_{p} = \frac{v - 0.5}{{k}_{y}} \qquad ( 5 )$$

In Expression (4), “kₓ” is a value obtained by dividing the first sub-pixel number by the first pixel number. In Expression (5), “k_{y}” is a value obtained by dividing the second sub-pixel number divided by the second pixel number.

In Expression (1), “C_{s,q}” is the gradation data corresponding to the color of the sub-pixel S corresponding to “Pᵣ” out of the three pieces of gradation data of the pixel G with a display column number “s” and a display row number “q”.

In Expression (1), “L_{s,q}” is the distance between the sub-pixel S corresponding to “Pᵣ” and the pixel G corresponding to “C_{s,q}”.

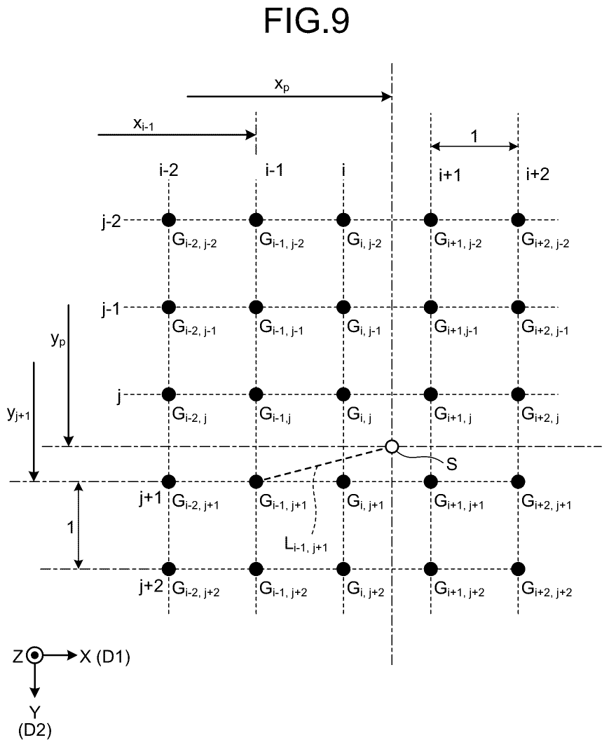

FIG. 9 is a diagram of the distance between the sub-pixel S and the pixel G. The distance between the sub-pixel S and the pixel G is the distance between the area centroid of the sub-pixel S and the area centroid of the pixel G in plan view. A point S indicates the area centroid of the sub-pixel S with the display column number “u” and the display row number “v”.

A plurality of points G indicate the area centroids of the pixels G in plan view. The pixels G each have a rectangular shape in plan view having one side of the length “1” as described above. Therefore, the points G are arrayed in a matrix (row-column configuration) such that the distance between two points G adjacent to each other in the first direction D1 is “1”, and the distance between two points G adjacent to each other in the second direction D2 is “1”. The indexes of the point G are the display column number and the display row number of the corresponding pixel G. For example, “G_{1,j}” indicates the area centroid of the pixel G with a display column number “i” and a display row number “j”.

Therefore, the distance “L_{s,q}” between the area centroid of the pixel G corresponding to “C_{s,q}” and the area centroid of the sub-pixel S corresponding to “Pᵣ” is calculated by Expression (6).

$${L}_{s , q} = \sqrt{{( {x}_{d} - {x}_{p} )}^{2} + {( {y}_{a} - {y}_{p} )}^{2}} \qquad ( 6 )$$

In Expression (6), “xₐ” and “yₐ” are the X- and Y-coordinates of the area centroid of the pixel G corresponding to “C_{s,q}”. “xₚ” and “yₚ” are the X- and Y-coordinates of the point S, which is the area centroid of the sub-pixel S as described above. FIG. 9 illustrates the distance “L_{i-1,i+1}” between the point S and a point G_{i-1,j+1}. At the point G_{i-1,j+1}, xₐ=xᵢ₋₁ is satisfied, and yₐ=yⱼ₊₁ is satisfied.

In Expression (1), the function “S(L_{s,q})” is used for bilinear interpolation and is expressed by Expression (7). As expressed by Expression (7), “S(L_{s,q})” derives “1−L_{s,q}” or “0” depending on the value of Lₛ,q.

$$S ( {L}_{s , q} ) = \{ \begin{matrix}1 - {L}_{s , q} & ( {L}_{s , q} < 1 ) \\ 0 & ( 1 ≦ {L}_{s , q} )\end{matrix} \qquad ( 7 )$$

In Expression (1), “kₐ” is a coefficient to adjust the brightness of an image used for bilinear interpolation and is expressed by Expression (8).

$${k}_{a} = {\sum }_{s = {i}_{p}}^{{i}_{p} + 1} {\sum }_{q = {i}_{p}}^{{j}_{p} + 1} S ( {L}_{s , q} ) \qquad ( 8 )$$

To calculate the sub-gradation data of the sub-pixel S positioned at the periphery of the display region DA in Expression (1), the gradation data of the pixel G positioned outside the display region DA may be required. Actually, however, no image, that is, no pixel G is present outside the display region DA. Therefore, in this case, the drive circuit 11 calculates the sub-gradation data using Expression (1) by disposing an imaginary pixel G having the same gradation data as that of the pixel G positioned at the periphery of the display region DA outside the display region DA.

As expressed by Expression (1), a variable s is a value in a range from “iₚ” to “iₚ+1”, and a variable q is a value in a range from “jₚ” to “jₚ+1”. Thus, the gradation data of up to four pixels G are selected to calculate the sub-gradation data of one sub-pixel S. In other words, the number of pixels G corresponding to “C_{s,q}” is up to four. The up to four pixels G correspond to the pixels G each of which is located at a distance equal to or shorter than a predetermined distance from the sub-pixel S as expressed by Expressions (6) and (7). The predetermined distance is a distance shorter than 1, which corresponds to the length of the side of the pixel G. A region in which the distance from the sub-pixel S is equal to or shorter than the predetermined distance is denoted as a predetermined region. The predetermined region is determined based on the distance between the sub-pixel S and the pixel G (between the area centroid of the sub-pixel S and the area centroid of the pixel G).

Thus, the drive circuit 11 generates the sub-gradation data based on the gradation data of the pixels G in the predetermined region and drives the sub-pixel S.

While Expressions (7) and (8) are functions used for bilinear interpolation, they may be functions used for other interpolations, such as nearest neighbor interpolation and bicubic interpolation. The number of pixels G to be selected in Expression (1) is not limited to up to four and may be up to nine, for example.

The above describes Expressions for calculating the sub-gradation data of the sub-pixel S with the display column number “u” and the display row number “v”.

Next, a case is described where the drive circuit 11 performs rendering using Expressions different from Expressions (1) to (8) above. As described above, the sub-pixels S arrayed in the display region DA constitute a plurality of sets of sub-pixels CS arrayed in a matrix (row-column configuration), and the sets of sub-pixels CS each correspond to a set of pixels CG.

With this configuration, in a set of sub-pixels CS, the distance between each of the sub-pixels S constituting the set of sub-pixels CS and each of the pixels G constituting a set of pixels CG corresponding to the set of sub-pixels CS can be calculated in advance. Therefore, in a set of sub-pixels CS, “S(L_{s,q})/kₐ” in Expression (1) corresponding to each of the sub-pixels S constituting the set of sub-pixels CS can be calculated in advance.

“S(L_{s,q})/kₐ” is the same value among the sub-pixels S corresponding to the same set column number and the same set row number in a plurality of sets of sub-pixels CS. Therefore, by calculating in advance “S(L_{s,q})/kₐ” corresponding to each of the sub-pixels S constituting a set of sub-pixels CS, and storing in advance the calculated values as coefficients in a storage area of the drive circuit 11, the step of calculating “S(L_{s,q})/kₐ” corresponding to all the sub-pixels S arrayed in the display region DA can be omitted.

In other words, by omitting the step of calculating “S(L_{s,q})/kₐ” in Expression (1) above, the rendering can be simplified compared with the case where Expressions (1) to (8) are used as described below in detail. Specifically, the drive circuit 11 generates the sub-gradation data for each of the sub-pixels S using Expressions (9) to (15).

$${P}_{r} = {\sum }_{ds = 0}^{1} {\sum }_{dq = 0}^{1} {C}_{ic , jc} {M}_{( du , dv , ds , dq )} \qquad ( 9 )$$

In Expression (9), “Pᵣ” is the sub-gradation data of the sub-pixel S with the display column number “u” and the display row number “v” as in Expression (1). A variable ds is “0” and “1”, and a variables dq is “0” and “1”. This indicates that the gradation data of four pixels G is used to calculate the sub-gradation data (“Pᵣ”) of one sub-pixel S.

“C_{ic,jc}” corresponds to the gradation data of the four pixels G used to calculate “Pᵣ”. “C_{ic,jc}” is the gradation data corresponding to the color of the sub-pixel S corresponding to “Pᵣ” out of the three pieces of gradation data of the pixel G with a display column number “ic” and a display row number “jc”. The relation between the sub-pixel S corresponding to “Pᵣ” and the four pixels G corresponding to “C_{ic,jc}” in Expression (9) is defined by the following Expressions (10) to (15) to be the same as the relation between the sub-pixel S corresponding to “Pr” and the four pixels G corresponding to “C_{s,q}” in Expression (1).

In “C_{ic,jc}”, “ic” is calculated by Expression (10), and “jc” is calculated by Expression (11).

$${i}_{c} = {i}_{c 0} ( N , M ) + {Rpp}_{x} ( du , dv ) + ds \qquad ( 10 )$$

$${j}_{c} = {j}_{c 0} ( N , M ) + {Rpp}_{y} ( du , dv ) + dq \qquad ( 11 )$$

In Expression (10), “i_{c0}(N,M)” is the display column number of a pixel G specified as a reference (hereinafter referred to as a reference pixel) positioned in a set of sub-pixels CS with a display column number “N” and a display row number “M” in which the sub-pixel S with the display column number “u” and the display row number “v” is positioned. The reference pixel is the pixel G positioned on the most −X side and the most −Y side in a set of pixels CG, for example. “N” is calculated by Expression (12), and “M” is calculated by Expression (13).

$$N = floor ( ( u - 1 ) / FIRST SUB - PIXEL NUMBER ) + 1 \qquad ( 12 )$$

$$M = floor ( ( v - 1 ) / SECOND SUB - PIXEL NUMBER ) + 1 \qquad ( 13 )$$

In Expression (10), “Rppₓ(du, dv)” is the difference between the set column number of the pixel G positioned on the most −X side and the most −Y side of the four pixels G used to generate the sub-gradation data and the set column number of the reference pixel.

“du” is the set column number of the sub-pixel S corresponding to “Pᵣ” and is calculated by Expression (14). A function “mod (α,β)” derives the remainder of dividing “α” by “β”. “du” is calculated as a natural number from 1 to the first sub-pixel number (10). “dv” is the set row number of the sub-pixel S corresponding to “Pᵣ” and is calculated by Expression (15). “dv” is calculated as a natural number from 1 to the second sub-pixel number (5).

$$du = mod ( u - 1 , FIRST SUB - PIXEL NUMBER ) + 1 \qquad ( 14 )$$

$$dv = mod ( v - 1 , SECOND SUB - PIXEL NUMBER ) + 1 \qquad ( 15 )$$

In Expression (11), “j_{c0}(N,M)” is the display column number of the reference pixel in the set of sub-pixels CS with the display column number “N” and the display row number “M” in which the sub-pixel S with the display column number “u” and the display row number “v” is positioned.

In Expression (10), “Rpp_{y}(du,dv)” is the difference between the set row number of the pixel G positioned on the most −X side and the most −Y side of the four pixels G having the gradation data used to generate the sub-gradation data and the set row number of the reference pixel.

In other words, the four pixels G corresponding to “C_{ic,jc}” in Expression (9) are specified by Expressions (10) to (15) using the display column number “u” and the display row number “v” of the sub-pixel S corresponding to “Pᵣ”.

In Expression (9), “M(du,dv,ds,dq)” corresponds to “S(L_{s,q})/kₐ” in Expression (1) and is a value calculated in advance as a coefficient. The number of “M(du,dv,ds,dq)” is a value obtained by multiplying the number of sub-pixels S in a set of sub-pixels CS (that is, a value obtained by multiplying the first sub-pixel number (5) by the second sub-pixel number (5)) by the number of pixels G (4) having the gradation data used to generate the sub-gradation data of one sub-pixel S. The number of “M(du,dv,ds,dq)” according to the first embodiment is 100 (=5×5×4).

The 100 coefficients corresponding to a set of sub-pixels CS can be used for another set of sub-pixels CS as described above. In other words, by storing in advance the 100 coefficients corresponding to a set of sub-pixels CS in the storage area of the drive circuit 11, the rendering can be performed without calculating “S(L_{s,q})/kₐ” in Expression (1) for all the sub-pixels S arrayed in the display region DA. Therefore, the time required for rendering can be reduced, and the display device 1 can achieve a relatively high refresh rate.

In this case, the area for storing the coefficients in the storage area of the drive circuit 11 can be made smaller than in a case where a plurality of sub-pixels S are not partitioned by sets of sub-pixels CS and the coefficients corresponding to all the sub-pixels S arrayed in the display region DA are calculated and stored in advance.

Specifically, let us assume a case where sub-pixels S are arrayed in a matrix (row-column configuration) with 7200 sub-pixels S arranged along the first direction D1 and 3600 sub-pixels S arranged along the second direction D2 in the display region DA, and these sub-pixels S correspond to pixels G arrayed in a matrix (row-column configuration) with 2880 pixels G arranged along the first direction D1 and 2880 pixels G arranged along the second direction D2 in the display region DA.

In the rendering using Expression (1), the number of times of calculating “S(L_{s,q})/kₐ” corresponds to a value obtained by multiplying the number of sub-pixels S (7200×3600) arrayed in the display region DA by the number of pixels G (4) corresponding to each of the sub-pixels S (103680000 (=7200×3600×4)). By contrast, the number of times of calculating “S(Ls,q)/kₐ” is zero in the rendering using Expression (9).

Let us assume a case where a plurality of sub-pixels S are not partitioned by sets of sub-pixels CS, and the coefficients corresponding to all the sub-pixels S arrayed in the display region DA are calculated and stored in advance, the number of coefficients corresponds to a value obtained by multiplying the number of sub-pixels S (7200×3600) arrayed in the display region DA by the number of pixels G (4) corresponding to the sub-pixels S (103680000 (=7200×3600×4)).

By contrast, when a plurality of sub-pixels S are partitioned by sets of sub-pixels CS as in the first embodiment, the number of coefficients is 100 as described above, and the size of the area for storing the coefficients in the storage area of the drive circuit 11 is 1/1036800 (=100/103680000) compared with the case where the plurality of sub-pixels S are not partitioned by the sets of sub-pixels CS.

### First Modification of the First Embodiment

The following describes a first modification of the first embodiment focusing mainly on the differences from the first embodiment. The first modification is different from the first embodiment in the configuration of a set of sub-pixels CS and the configuration of a set of pixels CG. A plurality of sub-pixels S according to the first modification constitute one (one type) set of sub-pixels CSa.

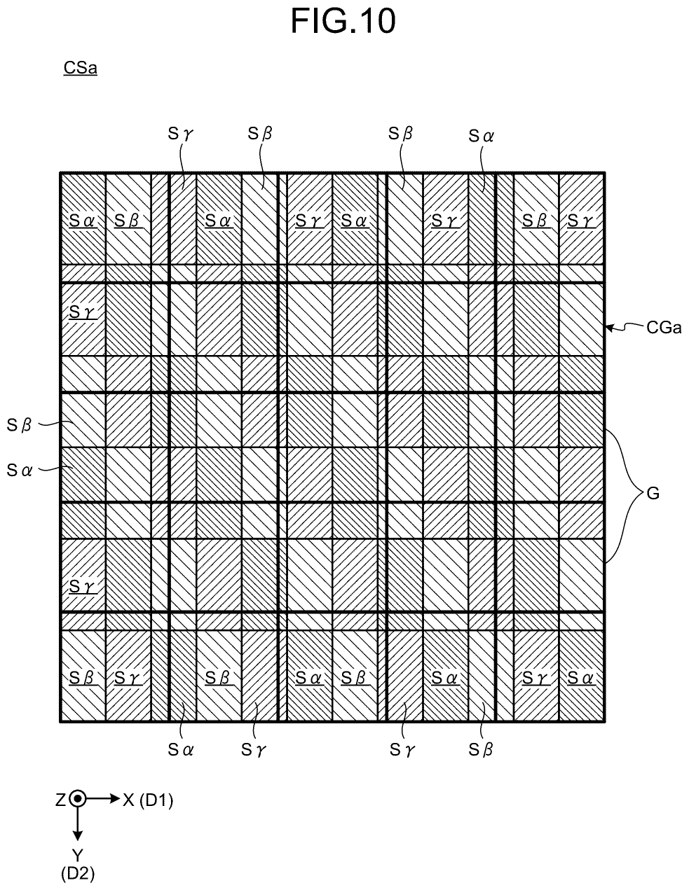

FIG. 10 is a plan view of the set of sub-pixels CSa according to the first modification of the first embodiment. The set of sub-pixels CSa is composed of sub-pixels S arrayed in a matrix (row-column configuration) with twelve sub-pixels S arranged along the first direction D1 and six sub-pixels S arranged along the second direction D2. In other words, in the first set of sub-pixels CSa, the first sub-pixel number is 12 and the second sub-pixel number is 6. In the set of sub-pixels CSa, the sub-pixel S with a set row number of 1 and a set column number of 1 is the first sub-pixel Sα; and the first sub-pixel Sα, the second sub-pixel Sβ, and third sub-pixel Sγ are disposed in the SQy1 array described above.

In a set of pixels CGa corresponding to the set of sub-pixels CSa, the first pixel number is 5, and the second pixel number is 5. Therefore, in the first modification, the value obtained by dividing the second sub-pixel number (6) by the second pixel number (5) is 1.2 (=6/5), which is larger than 1 and smaller than 1.5. The value obtained by multiplying the first sub-pixel number (12) by the first pixel number (5) is 2.4 (=12/5), which is larger than 2 and smaller than 3.

The total of the numbers of the first sub-pixels Sα, the second sub-pixels Sβ, and the third sub-pixels Sγ included in the set of sub-pixels CSa (total number of the sub-pixels S) is 72 (=12×6), which is a value obtained by multiplying the first sub-pixel number (12) by the second sub-pixel number (6). By contrast, the total of the numbers of the first gradation data, the second gradation data, and the third gradation data of the pixels G constituting the set of pixels CGa corresponding to the set of sub-pixels CSa is 75 (=5×5×3), which is a value obtained by multiplying the first pixel number (5), the second pixel number (5), and the number of gradation data (3) included in the pixel G together. Therefore, the ratio of the gradation data (75) to the total number of the sub-pixels S (72) is 0.96 (=72/75), which is in a range of 0.9 to 1.1.

In the first modification, the sub-pixels S are disposed in the SQy1 array described above in the display region DA. Therefore, a plurality of sets of sub-pixels CSa are arrayed in a matrix (row-column configuration) along the first direction D1 and the second direction D2.

### Second Modification of the First Embodiment

The following describes a second modification of the first embodiment focusing mainly on the differences from the first embodiment. The second modification is different from the first embodiment in the configuration of a set of sub-pixels CS and the configuration of a set of pixels CG.

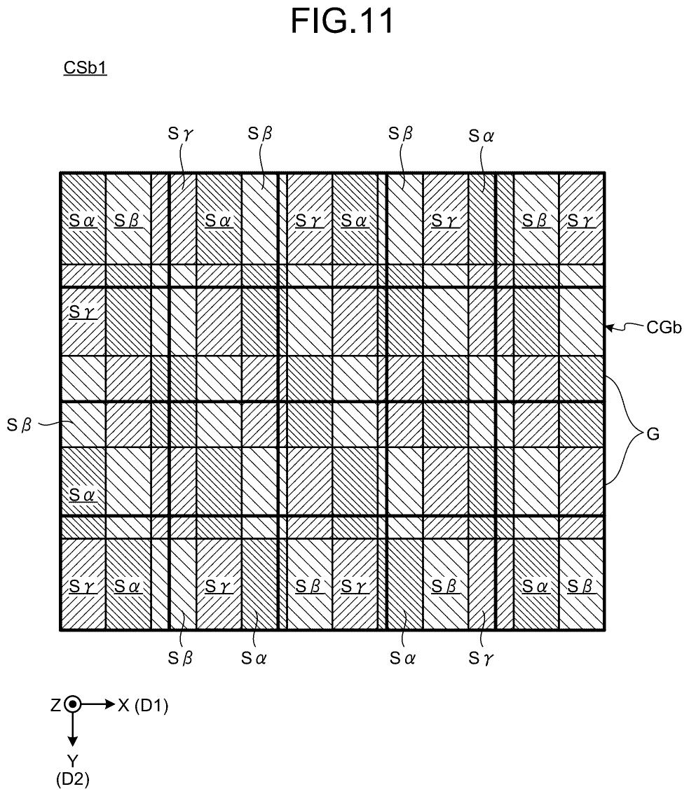

FIG. 11 is a plan view of a first set of sub-pixels Csb1 according to the second modification of the first embodiment. The first set of sub-pixels CSb1 is composed of sub-pixels S arrayed in a matrix (row-column configuration) with twelve sub-pixels S arranged along the first direction D1 and five sub-pixels S arranged along the second direction D2. In other words, in the first set of sub-pixels CSb1, the first sub-pixel number is 12, and the second sub-pixel number is 5. In the first set of sub-pixels CSb1, the sub-pixel S with a set row number of 1 and a set column number of 1 is the first sub-pixel Sα; and the first sub-pixel Sα, the second sub-pixel Sβ, and third sub-pixel Sγ are disposed in the SQy1 array described above.

In a set of pixels CGb corresponding to the first set of sub-pixels CSb1, the first pixel number is 5, and the second pixel number is 4. Therefore, in the second modification, the value obtained by dividing the second sub-pixel number (5) by the second pixel number (4) is 1.25 (=5/4), which is larger than 1 and smaller than 1.5. The value obtained by multiplying the first sub-pixel number (12) by the first pixel number (5) is 2.4 (=12/5), which is larger than 2 and smaller than 3.

The total of the numbers of the first sub-pixels Sα, the second sub-pixels Sβ, and the third sub-pixels Sγ included in the first set of sub-pixels CSb1 (total number of the sub-pixels S) is 60 (=12×5), which is a value obtained by multiplying the first sub-pixel number (12) by the second sub-pixel number (5). By contrast, the total of the numbers of the first gradation data, the second gradation data, and the third gradation data of the pixels G constituting the set of pixels CGb corresponding to the first set of sub-pixels CSb1 (total number of the gradation data) is 60 (=5×4×3), which is a value obtained by multiplying the first pixel number (5), the second pixel number (4), and the number of gradation data (3) included in the pixel G together. Therefore, the ratio of the gradation data (60) to the total number of the sub-pixels S (60) is 1 (=60/60), which is in a range of 0.9 to 1.1.

A second set of sub-pixels (not illustrated) according to the second modification is different from the first set of sub-pixels CSb1 described above only in the arrangement of the sub-pixels S. Specifically, in the second set of sub-pixels, the first sub-pixel Sa of the first set of sub-pixels CSb1 is replaced by the second sub-pixel Sβ, the second sub-pixel SB of the first set of sub-pixels CSb1 is replaced by the third sub-pixel Sγ, and the third sub-pixel Sγ of the first set of sub-pixels CSb1 is replaced by the first sub-pixel Sα. In other words, in the second set of sub-pixels, the sub-pixel S with a set row number of 1 and a set column number of 1 is the second sub-pixel Sβ; and the first sub-pixel Sα, the second sub-pixel Sβ, and the third sub-pixel Sγ are disposed in the SQy1 array described above.

A third set of sub-pixels (not illustrated) according to the second modification is different from the first set of sub-pixels CSb1 described above only in the arrangement of the sub-pixels S. Specifically, in the third set of sub-pixels, the first sub-pixel Sa of the first set of sub-pixels CSb1 is replaced by the third sub-pixel Sγ, the second sub-pixel SB of the first set of sub-pixels CSb1 is replaced by the first sub-pixel Sα, and the third sub-pixel Sγ of the first set of sub-pixels CSb1 is replaced by the second sub-pixel Sβ. In other words, in the third set of sub-pixels, the sub-pixel S with a set row number of 1 and a set column number of 1 is the third sub-pixel Sγ; and the first sub-pixel Sα, the second sub-pixel Sβ, and the third sub-pixel Sγ are disposed in the SQy1 array described above.

By disposing the sub-pixels S in the SQy1 array described above in the display region DA, a plurality of sets of sub-pixels CSb are disposed as follows: the first sets of sub-pixels CSb1 are arrayed along the first direction D1 in a first row; the second sets of sub-pixels are arrayed along the first direction D1 in a second row; the third sets of sub-pixels are arrayed along the first direction D1 in a third row; and the first row, the second row, and the third row are repeatedly disposed in this order along the second direction D2.

### Third Modification of the First Embodiment

The following describes a third modification of the first embodiment focusing mainly on the differences from the first embodiment. The third modification is different from the first embodiment in the configuration of a set of sub-pixels CS and the configuration of a set of pixels CG.

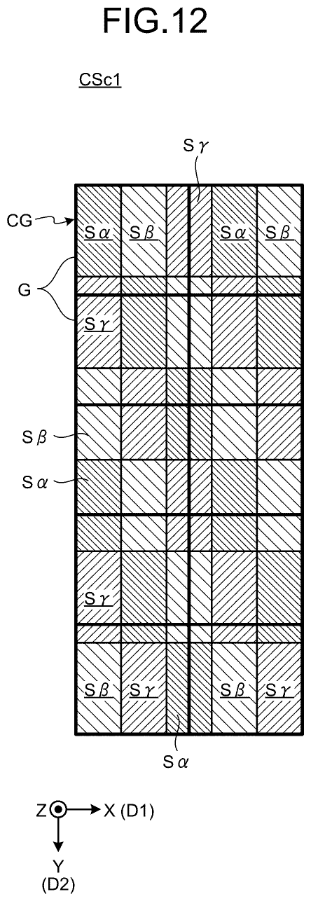

FIG. 12 is a plan view of a first set of sub-pixels CSc1 according to the third modification of the first embodiment. The first set of sub-pixels CSc1 is composed of sub-pixels S arrayed in a matrix (row-column configuration) with five sub-pixels S arranged along the first direction D1 and six sub-pixels S arranged along the second direction D2. In other words, in the first set of sub-pixels CSc1, the first sub-pixel number is 5, and the second sub-pixel number is 6. In the first set of sub-pixels CSc1, the sub-pixel S with a set row number of 1 and a set column number of 1 is the first sub-pixel Sα; and the first sub-pixel Sα, the second sub-pixel Sβ, and third sub-pixel Sγ are disposed in the SQy1 array described above.

In a set of pixels CGc corresponding to the first set of sub-pixels CSc1, the first pixel number is 2, and the second pixel number is 5. Therefore, in the third modification, the value obtained by dividing the second sub-pixel number (6) by the second pixel number (5) is 1.2 (=6/5), which is larger than 1 and smaller than 1.5. The value obtained by multiplying the first sub-pixel number (5) by the first pixel number (2) is 2.5 (=5/2), which is larger than 2 and smaller than 3.

The total of the numbers of the first sub-pixels Sα, the second sub-pixels Sβ, and the third sub-pixels Sγ included in the first set of sub-pixels CSc1 (total number of the sub-pixels S) is 30 (=5×6), which is a value obtained by multiplying the first sub-pixel number (5) by the second sub-pixel number (6). By contrast, the total of the numbers of the first gradation data, the second gradation data, and the third gradation data of the pixels G constituting the set of pixels CGc corresponding to the first set of sub-pixels CSc1 (total number of the gradation data) is 30 (=2×5×3), which is a value obtained by multiplying the first pixel number (2), the second pixel number (5), and the number of gradation data (3) included in the pixel G together. Therefore, the ratio of the gradation data (30) to the total number of the sub-pixels S (30) is 1 (=30/30), which is in a range of 0.9 to 1.1.

A second set of sub-pixels (not illustrated) is different from the first set of sub-pixels CSc1 described above only in the arrangement of the sub-pixels S. Specifically, in the second set of sub-pixels, the first sub-pixel Sa of the first set of sub-pixels CSc1 is replaced by the third sub-pixel Sγ, the second sub-pixel SB of the first set of sub-pixels CSc1 is replaced by the first sub-pixel Sα, and the third sub-pixel Sγ of the first set of sub-pixels CSc1 is replaced by the second sub-pixel Sβ. In other words, in the second set of sub-pixels, the sub-pixel S with a set row number of 1 and a set column number of 1 is the third sub-pixel Sγ; and the first sub-pixel Sα, the second sub-pixel SR, and the third sub-pixel Sγ are disposed in the SQy1 array described above.

A third set of sub-pixels (not illustrated) is different from the first set of sub-pixels CSc1 described above only in the arrangement of the sub-pixels S. Specifically, in the third set of sub-pixels, the first sub-pixel Sa of the first set of sub-pixels CSc1 is replaced by the second sub-pixel Sβ, the second sub-pixel SB of the first set of sub-pixels CSc1 is replaced by the third sub-pixel Sγ, and the third sub-pixel Sγ of the first set of sub-pixels CSc1 is replaced by the first sub-pixel Sα. In other words, in the third set of sub-pixels, the sub-pixel S with a set row number of 1 and a set column number of 1 is the second sub-pixel Sβ; and the first sub-pixel Sα, the second sub-pixel Sβ, and the third sub-pixel Sγ are disposed in the SQy1 array described above. By disposing the sub-pixels S in the SQy1 array described above in the display region DA, a plurality of sets of sub-pixels CSc are disposed as follows: the first sets of sub-pixels CSc1 are arrayed along the second direction D2 in a first column; the second sets of sub-pixels are arrayed along the second direction D2 in a second column; the third sets of sub-pixels are arrayed along the second direction D2 in a third column; and the first column, the second column, and the third column are repeatedly disposed in this order along the first direction D1.

### Fourth Modification of the First Embodiment

The following describes a fourth modification of the first embodiment focusing mainly on the differences from the first embodiment. The fourth modification is different from the first embodiment in the configuration of a set of sub-pixels CS and the configuration of a set of pixels CG.

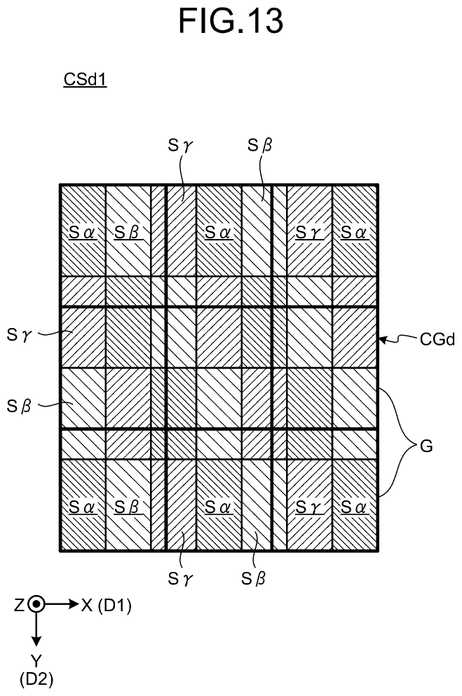

FIG. 13 is a plan view of a first set of sub-pixels Csd1 according to the fourth modification of the first embodiment. The first set of sub-pixels CSd1 is composed of sub-pixels S arrayed in a matrix (row-column configuration) with seven sub-pixels S arranged along the first direction D1 and four sub-pixels S arranged along the second direction D2. In other words, in the first set of sub-pixels CSd1, the first sub-pixel number is 7, and the second sub-pixel number is 4. In the first set of sub-pixels CSd1, the sub-pixel S with a set row number of 1 and a set column number of 1 is the first sub-pixel Sα; and the first sub-pixel Sα, the second sub-pixel Sβ, and third sub-pixel Sγ are disposed in the SQy1 array described above.

In a set of pixels CGd corresponding to the first set of sub-pixels CSd1, the first pixel number is 3, and the second pixel number is 3. Therefore, in the fourth modification, the value obtained by dividing the second sub-pixel number (4) by the second pixel number (3) is 1.33 (=4/3), which is larger than 1 and smaller than 1.5. The value obtained by dividing the first sub-pixel number (7) by the first pixel number (3) is 2.3 (=7/3), which is larger than 2 and smaller than 3.

The total of the numbers of the first sub-pixels Sα, the second sub-pixels Sβ, and the third sub-pixels Sγ included in the first set of sub-pixels CSd1 (total number of the sub-pixels S) is 28 (=7×4), which is a value obtained by multiplying the first sub-pixel number (7) by the second sub-pixel number (4). By contrast, the total of the numbers of the first gradation data, the second gradation data, and the third gradation data of the pixels G constituting the set of pixels CGd corresponding to the first set of sub-pixels CSd1 (total number of the gradation data) is 27 (=3×3×3), which is a value obtained by multiplying the first pixel number (3), the second pixel number (3), and the number of gradation data (3) included in the pixel G together. Therefore, the ratio of the gradation data (27) to the total number of the sub-pixels S (28) is 1.037 (=28/27), which is in a range of 0.9 to 1.1.

A second set of sub-pixels (not illustrated) is different from the first set of sub-pixels CSd1 described above only in the arrangement of the sub-pixels S. Specifically, in the second set of sub-pixels, the first sub-pixel Sa of the first set of sub-pixels CSd1 is replaced by the second sub-pixel Sβ, the second sub-pixel SB of the first set of sub-pixels CSd1 is replaced by the third sub-pixel Sγ, and the third sub-pixel Sγ of the first set of sub-pixels CSd1 is replaced by the first sub-pixel Sα. In other words, in the second set of sub-pixels, the sub-pixel S with a set row number of 1 and a set column number of 1 is the second sub-pixel Sβ; and the first sub-pixel Sα, the second sub-pixel Sβ, and the third sub-pixel Sγ are disposed in the SQy1 array described above.

A third set of sub-pixels (not illustrated) is different from the first set of sub-pixels CSd1 described above only in the arrangement of the sub-pixels S. Specifically, in the third set of sub-pixels, the first sub-pixel Sa of the first set of sub-pixels CSd1 is replaced by the third sub-pixel Sγ, the second sub-pixel SB of the first set of sub-pixels CSd1 is replaced by the first sub-pixel Sα, and the third sub-pixel Sγ of the first set of sub-pixels CSd1 is replaced by the second sub-pixel Sβ. In other words, in the third set of sub-pixels, the sub-pixel S with a set row number of 1 and a set column number of 1 is the third sub-pixel Sγ; and the first sub-pixel Sα, the second sub-pixel Sβ, and the third sub-pixel Sγ are disposed in the SQy1 array described above.

By disposing the sub-pixels S in the SQy1 array described above in the display region DA, a plurality of sets of sub-pixels CSd are disposed as follows: the first set of sub-pixels CSd1, the second set of sub-pixels, and the third set of sub-pixels are repeatedly disposed in this order along the first direction D1; and the first set of sub-pixels CSd1, the third set of sub-pixels, and the second set of sub-pixels are repeatedly disposed in this order along the second direction D2.

### Fifth Modification of the First Embodiment

The following describes a fifth modification of the first embodiment focusing mainly on the differences from the first embodiment. The fifth modification is different from the first embodiment in the configuration of a set of sub-pixels CS and the configuration of a set of pixels CG.

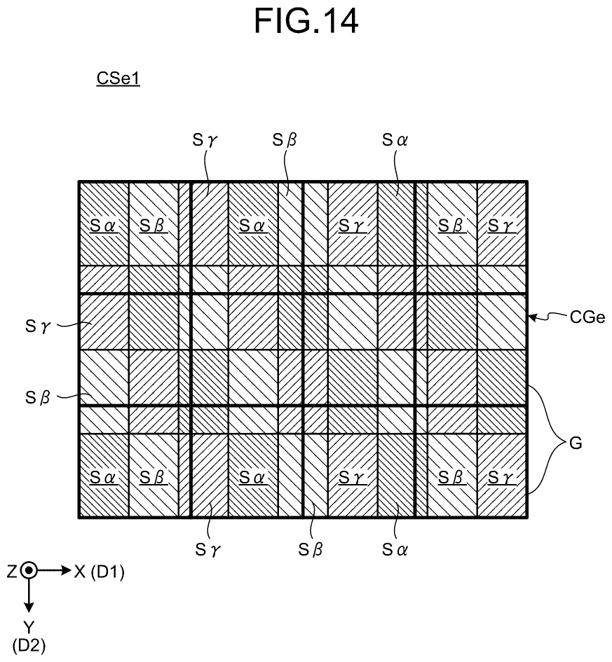

FIG. 14 is a plan view of a first set of sub-pixels CSe1 according to the fifth modification of the first embodiment. The first set of sub-pixels CSe1 is composed of sub-pixels S arrayed in a matrix (row-column configuration) with nine sub-pixels S arranged along the first direction D1 and four sub-pixels S arranged along the second direction D2. In other words, in the first set of sub-pixels CSe1, the first sub-pixel number is 9, and the second sub-pixel number is 4. In the first set of sub-pixels CSe1, the sub-pixel S with a set row number of 1 and a set column number of 1 is the first sub-pixel Sα; and the first sub-pixel Sα, the second sub-pixel Sβ, and third sub-pixel Sγ are disposed in the SQy1 array described above.

In a set of pixels CGe corresponding to the first set of sub-pixels CSe1, the first pixel number is 4, and the second pixel number is 3. Therefore, in the fifth modification, the value obtained by dividing the second sub-pixel number (4) by the second pixel number (3) is 1.33 (=4/3), which is larger than 1 and smaller than 1.5. The value obtained by dividing the first sub-pixel number (9) by the first pixel number (4) is 2.25 (=9/4), which is larger than 2 and smaller than 3.

The total of the numbers of the first sub-pixels Sα, the second sub-pixels Sβ, and the third sub-pixels Sγ included in the first set of sub-pixels CSe1 (total number of the sub-pixels S) is 36 (=9×4), which is a value obtained by multiplying the first sub-pixel number (9) by the second sub-pixel number (4). By contrast, the total of the numbers of the first gradation data, the second gradation data, and the third gradation data of the pixels G constituting the set of pixels CGe corresponding to the first set of sub-pixels CSe1 (total number of the gradation data) is 36 (=4×3×3), which is a value obtained by multiplying the first pixel number (4), the second pixel number (3), and the number of gradation data (3) included in the pixel G together. Therefore, the ratio of the gradation data (36) to the total number of the sub-pixels S (36) is 1.0 (=36/36), which is in a range of 0.9 to 1.1.

A second set of sub-pixels (not illustrated) is different from the first set of sub-pixels CSe1 described above only in the arrangement of the sub-pixels S. Specifically, in the second set of sub-pixels, the first sub-pixel Sa of the first set of sub-pixels CSe1 is replaced by the third sub-pixel Sγ, the second sub-pixel SB of the first set of sub-pixels CSe1 is replaced by the first sub-pixel Sα, and the third sub-pixel Sγ of the first set of sub-pixels CSe1 is replaced by the second sub-pixel Sβ. In other words, in the second set of sub-pixels, the sub-pixel S with a set row number of 1 and a set column number of 1 is the third sub-pixel Sγ; and the first sub-pixel Sα, the second sub-pixel Sβ, and the third sub-pixel Sγ are disposed in the SQy1 array described above.

A third set of sub-pixels (not illustrated) is different from the first set of sub-pixels CSe1 described above only in the arrangement of the sub-pixels S. Specifically, in the third set of sub-pixels, the first sub-pixel Sa of the first set of sub-pixels CSe1 is replaced by the second sub-pixel Sβ, the second sub-pixel SB of the first set of sub-pixels CSe1 is replaced by the third sub-pixel Sγ, and the third sub-pixel Sγ of the first set of sub-pixels CSe1 is replaced by the first sub-pixel Sα. In other words, in the third set of sub-pixels, the sub-pixel S with a set row number of 1 and a set column number of 1 is the second sub-pixel Sβ; and the first sub-pixel Sα, the second sub-pixel Sβ, and the third sub-pixel Sγ are disposed in the SQy1 array described above.

By disposing the sub-pixels S in the SQy1 array described above in the display region DA, a plurality of sets of sub-pixels CSe are disposed as follows: the first sets of sub-pixels CSe1 are arrayed along the first direction D1 in a first row; the second sets of sub-pixels are arrayed along the first direction D1 in a second row; the third sets of sub-pixels are arrayed along the first direction D1 in a third row; and the first row, the second row, and the third row are repeatedly disposed in this order along the second direction D2.

### Second Embodiment

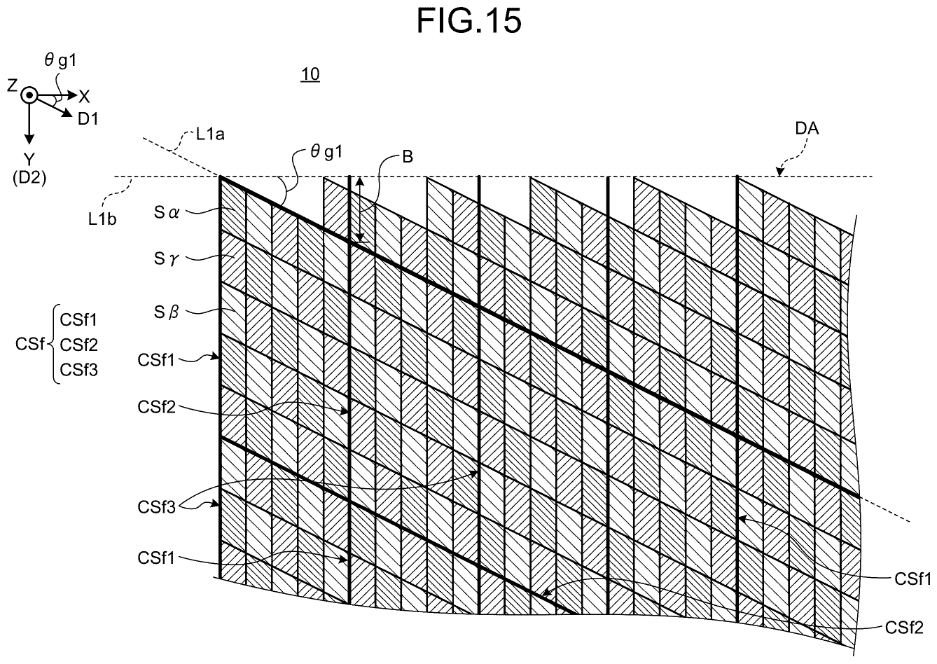

The following describes a second embodiment of the present disclosure focusing mainly on the differences from the first embodiment. FIG. 15 is a plan view of the display panel 10 indicating the array of a plurality of sets of sub-pixels CSf according to the second embodiment of the present disclosure.

In the display device 1 according to the second embodiment, the first direction D1 is inclined with respect to the second direction D2 compared with the first embodiment described above. Specifically, the first direction D1 is inclined with respect to the X- and Y-directions. The first direction D1 is parallel to a dashed line L1a having an inclination angle θg1 with respect to a dashed line L1b parallel to the X-direction in plan view. The second direction D2 is parallel to the Y-direction as in the first embodiment. The X-direction according to the second embodiment corresponds to a “third direction”.

The inclination angle θg1 is defined as an angle where tan θg1=A×(1/First Pixel Number) is satisfied (“A” is a natural number or the reciprocal of a natural number). FIG. 15 illustrates a case where A=1 is satisfied. When A=1 is satisfied, and the first pixel number is “2” as in the first embodiment, tan θg1=1/2 and the inclination angle θg1=26.6° are satisfied.

The sub-pixels S are arrayed in a matrix (row-column configuration) along the first direction D1 and the second direction D2 as in the first embodiment. The sub-pixel S has a parallelogrammatic shape in plan view. The array of the sub-pixels S is the SQy1 array as in the first embodiment. In the display region DA, a plurality of sets of sub-pixels CSf are arrayed along the first direction D1 and the second direction D2. In a set of sub-pixels CSf, the first sub-pixel number is 5, and the second sub-pixel number is 5 as in the first embodiment.

By defining the inclination angle θg1 as described above, a plurality of sets of pixels CGf corresponding to a plurality of sets of sub-pixels CSf do not overlap each other and are arrayed along the first direction D1 and the second direction D2 with no space interposed therebetween in the display region DA as described below. In two sets of sub-pixels CSf adjacent to each other in the first direction D1, a distance B in the Y-direction between the sub-pixels S corresponding to the same set column number out of the sub-pixels S arrayed in the same row along the first direction D1 is A times the length of the pixel G in the Y-direction (=1).

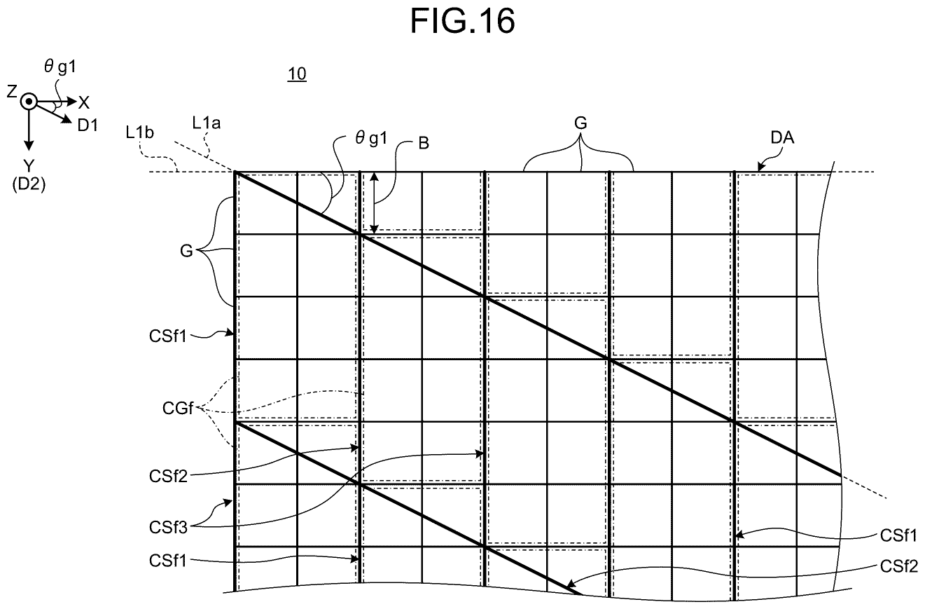

FIG. 16 is a diagram of the positional relation between a plurality of sets of sub-pixels CSf and a plurality of sets of pixels CGf according to the second embodiment of the present disclosure. As in the first embodiment, a plurality of pixels G are arrayed in a matrix (row-column configuration) along the X- and Y-directions. In a set of pixels CGf, the first pixel number is 2, and the second pixel number is 4.

The length in the X-direction of a set of pixels CGf is equal to that of a set of sub-pixels CSf. The length in the Y-direction of the sides on the −X side and the +X side of a set of pixels CGf is equal to that of a set of sub-pixels CSf.

A plurality of sets of pixels CGf are arrayed such that the side on the −X side of a set of pixels CGf matches the side on the −X side of a set of sub-pixels CSf. By disposing a set of pixels CGf in this manner, a plurality of sets of pixels CGf do not overlap each other and are arrayed along the first direction D1 and the second direction D2 with no space interposed therebetween in the display region DA. The set of pixels CGf corresponding to a set of sub-pixels CSf is a set of pixels CGf having the side on the −X side that matches the side on the −X side of the set of sub-pixels CSf.

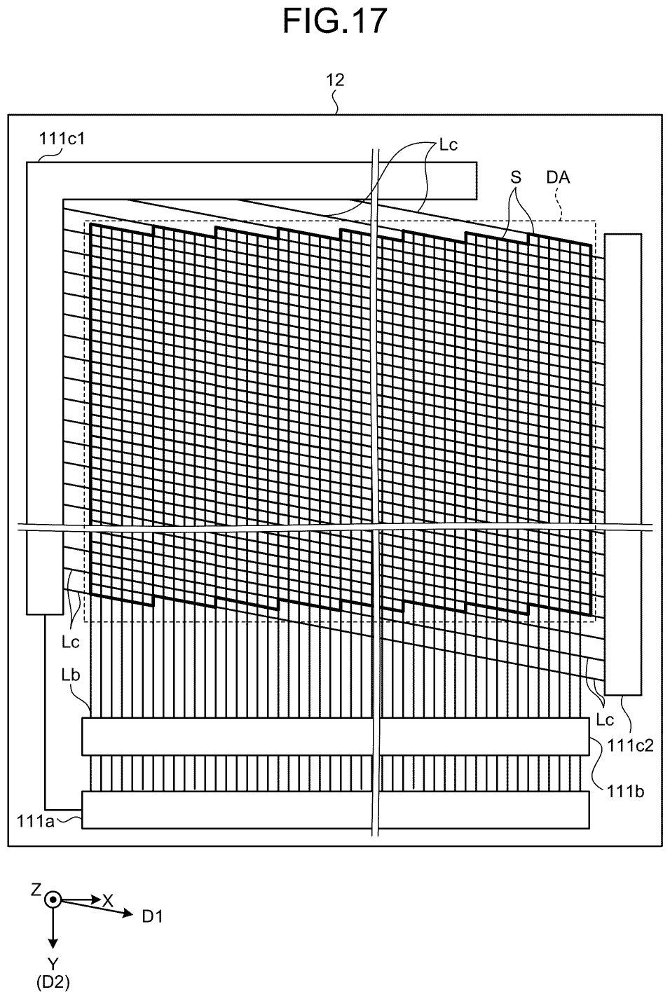

FIG. 17 is a diagram of the circuit configuration of the display panel 10 according to the second embodiment. A plurality of sub-pixels S according to the second embodiment are arrayed along the first direction D1 as described above, so the scanning lines Lc also are disposed along the first direction D1. In other words, the scanning lines Lc according to the second embodiment are disposed in a manner inclined with respect to the X- and Y-directions. As a result, the scanning lines Lc according to the second embodiment are disposed also on the +Y side and the −Y side of the display region DA.

By contrast, the scanning lines Lc according to the first embodiment extend along the X-direction as illustrated in FIG. 2 and are not disposed on the +Y side or the −Y side of the display region DA unlike the scanning lines Lc according to the second embodiment. Therefore, the number of scanning lines Lc according to the second embodiment illustrated in FIG. 17 is larger than the number of scanning lines Lc according to the first embodiment described above. The same applies to a case where the array of the sub-pixels S is the SQy pixel array and the stripe pixel array for comparison.

In the generation of the sub-gradation data using Expression (1), the Y-coordinate of the sub-pixel S is calculated by Expression (16) instead of Expression (5). In Expression (16), “u₀” is a value indicating the display column number of the sub-pixel S serving as a reference and is 1, for example.

$${y}_{p} = \frac{v - 0.5}{{k}_{y}} + \frac{( u - {u}_{0} ) tan ( {θ}_{g} )}{{k}_{x}} \qquad ( 16 )$$

In the generation of the sub-gradation data using Expression (9), M in Expression (13) is calculated by Expressions (17) and (18).

$$M = floor ( ( v - 1 ) / SECOND SUB - PIXEL NUMBER ) + 1 + floor ( ( N - 1 + dv 0 - 1 ) / SECOND SUB - PIXEL NUMBER ) \qquad ( 17 )$$

$$dv 0 = mod ( v - 1 , SECOND SUB - PIXEL NUMBER ) + 1 \qquad ( 18 )$$

Thus, the display device 1 according to the second embodiment can achieve high resolution and a relatively high refresh rate as in the first embodiment if the first direction D1 is inclined with respect to the X- and Y-directions.

### First Modification of the Second Embodiment

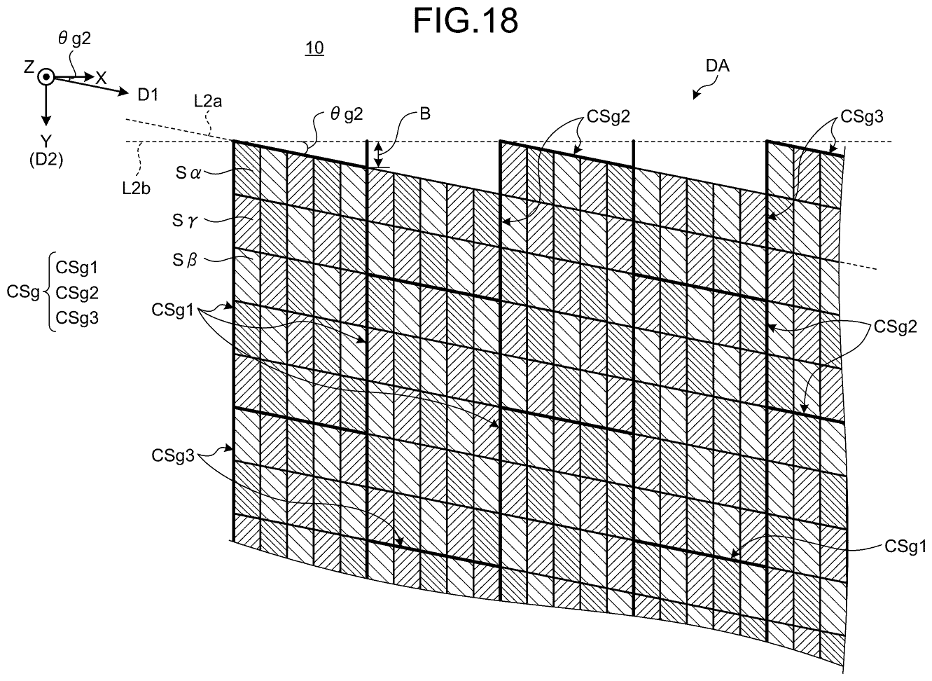

The following describes a first modification of the second embodiment focusing mainly on the differences from the second embodiment. FIG. 18 is a plan view of the display panel 10 indicating the array of a plurality of sets of sub-pixels CSg according to a first modification of the second embodiment.

In the display device 1 according to the first modification, the magnitude of the inclination angle is different from that according to the second embodiment. The first direction D1 is parallel to a dashed line L2a having an inclination angle θg2 with respect to a dashed line L2b parallel to the X-direction in plan view. As in the second embodiment, the second direction D2 is parallel to the Y-direction, and the X-direction corresponds to the “third direction”.

The inclination angle θg2 is defined as an angle where tan θg2=A×(Second Pixel Number/(First Pixel Number×Second Sub-Pixel Number)) is satisfied (“A” is a natural number or the reciprocal of a natural number). FIG. 18 illustrates a case where A=1/2 is satisfied. When A=1/2 is satisfied, and the second pixel number is “4”, the first pixel number is “2”, and the second sub-pixel number is “5” as in the first embodiment, tan θg2=1/5 and the inclination angle θg2=11.3° are satisfied.

As in the second embodiment, the sub-pixels S are arrayed in a matrix (row-column configuration) along the first direction D1 and the second direction D2, and the array of the sub-pixels S is the SQy1 array.

In the display region DA, a plurality of sets of sub-pixels CSg are arrayed along the first direction D1 and the second direction D2. In a set of sub-pixels CSg, the first sub-pixel number is 5, and the second sub-pixel number is 5 as in the first embodiment.

By defining the inclination angle θg2 as described above, a plurality of sets of pixels CGg corresponding to a plurality of sets of sub-pixels CSg do not overlap each other and are arrayed along the first direction D1 and the second direction D2 with no space interposed therebetween in the display region DA as described below. In two sets of sub-pixels CSg adjacent to each other in the first direction D1, the distance B in the Y-direction between the sub-pixels S corresponding to the same set column number out of the sub-pixels S arrayed in the same row along the first direction D1 is A×(Second Pixel Number/Second Sub-Pixel Number) times the length of the pixel G in the Y-direction (=1).

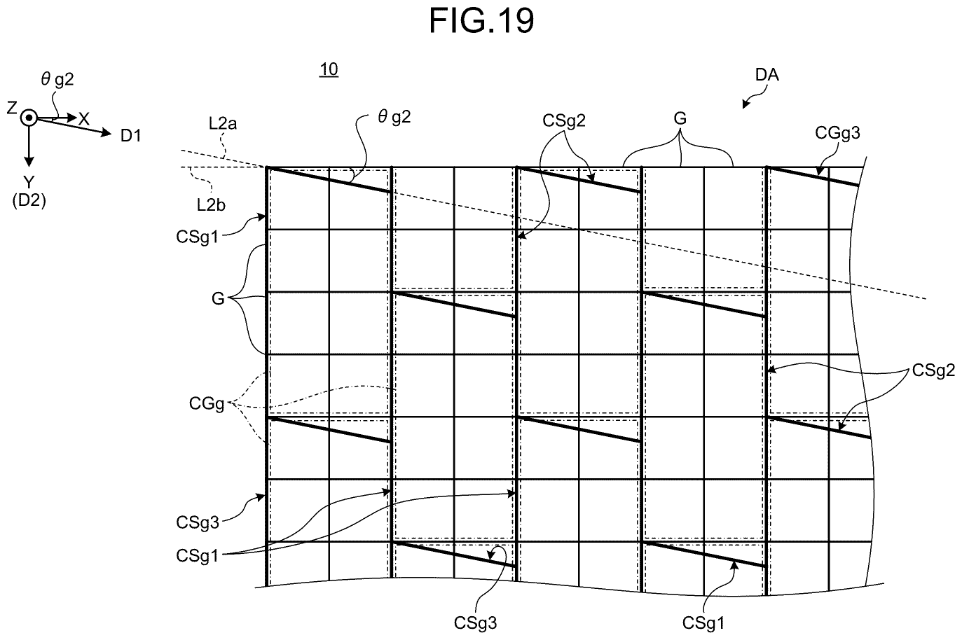

FIG. 19 is a diagram of the positional relation between a plurality of sets of sub-pixels CSg and a plurality of sets of pixels CGg according to the first modification of the second embodiment of the present disclosure. As in the second embodiment, a plurality of pixels G are arrayed in a matrix (row-column configuration) along the X- and Y-directions. In a set of pixels CGg, the first pixel number is 2, and the second pixel number is 4.

The length in the X-direction of a set of pixels CGg is equal to that of a set of sub-pixels CSg. The length in the Y-direction of the sides on the −X side and the +X side of a set of pixels CGg is equal to that of a set of sub-pixels CSg.

A plurality of sets of pixels CGg are arrayed such that the side on the −X side of a set of pixels CGg matches the side on the −X side of a set of sub-pixels CSg. By disposing a set of pixels CGg in this manner, a plurality of sets of pixels CGg do not overlap each other and are arrayed along the first direction D1 and the second direction D2 with no space interposed therebetween in the display region DA. The set of pixels CGg corresponding to a set of sub-pixels CSg is a set of pixels CGg having the side on the −X side that matches the side on the −X side of the set of sub-pixels CSg.

The display device 1 according to the first modification can achieve high resolution and a relatively high refresh rate as in the second embodiment.

### Second Modification of the Second Embodiment

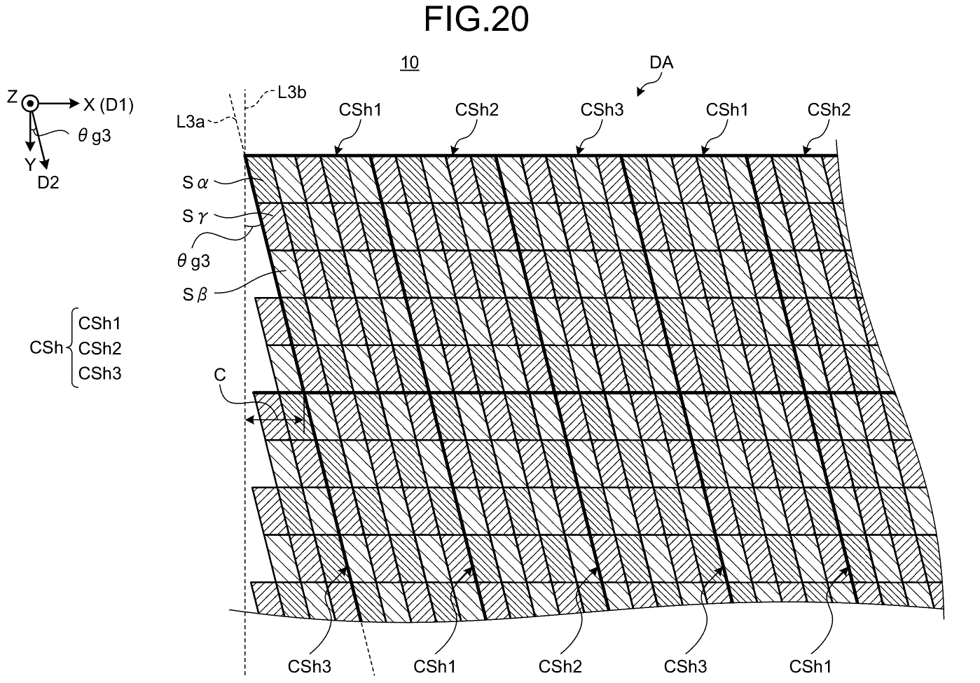

The following describes a second modification of the second embodiment focusing mainly on the differences from the first embodiment. FIG. 20 is a plan view of the display panel 10 indicating the array of a plurality of sets of sub-pixels CSh according to the second modification of the second embodiment of the present disclosure.

In the display device 1 according to the second modification, the second direction D2 is inclined with respect to the first direction D1 compared with the first embodiment described above. Specifically, the second direction D2 is inclined with respect to the X- and Y-directions. The second direction D2 is parallel to a dashed line L3a having an inclination angle θg3 with respect to a dashed line L3b parallel to the Y-direction in plan view. The first direction D1 is parallel to the X-direction as in the first embodiment. The Y-direction according to the second modification corresponds to the “third direction”.

The inclination angle θg3 is defined as a value where tan θg3=A×(1/Second Pixel Number) is satisfied (“A” is a natural number or the reciprocal of a natural number). FIG. 20 illustrates a case where A=1 is satisfied. When A=1 is satisfied, and the second pixel number is “4” as in the first embodiment, tan θg3=1/4 and the inclination angle θg3=14.0° are satisfied.

The sub-pixels S are arrayed in a matrix (row-column configuration) along the first direction D1 and the second direction D2. The array of the sub-pixels S is the SQy1 array as in the first embodiment.

In the display region DA, a plurality of sets of sub-pixels CSh are arrayed along the first direction D1 and the second direction D2. In a set of sub-pixels CSh, the first sub-pixel number is 5, and the second sub-pixel number is 5 as in the first embodiment.

By defining the inclination angle θg3 as described above, a plurality of sets of pixels CGh corresponding to a plurality of sets of sub-pixels CSh do not overlap each other and are arrayed along the first direction D1 and the second direction D2 with no space interposed therebetween in the display region DA as described below. In two sets of sub-pixels CSh adjacent to each other in the second direction D2, a distance C in the X-direction between the sub-pixels S corresponding to the same set row number out of the sub-pixels S arrayed in the same column along the second direction D2 is A times the length of the pixel G in the X-direction (=1).

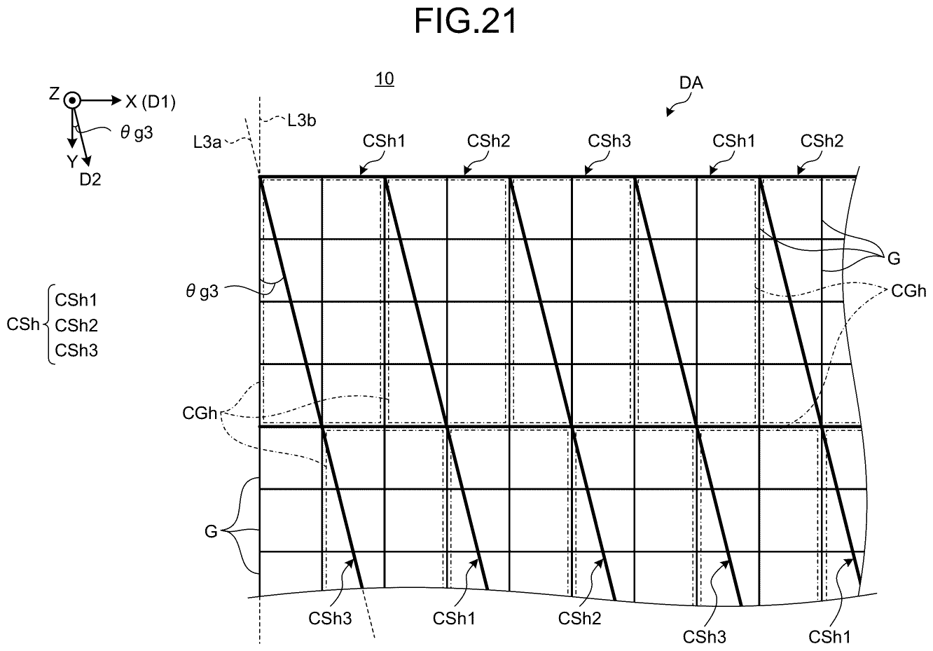

FIG. 21 is a diagram of the positional relation between a plurality of sets of sub-pixels CSh and a plurality of sets of pixels CGh according to the second modification of the second embodiment of the present disclosure. As in the first embodiment, a plurality of pixels G are arrayed in a matrix (row-column configuration) along the X- and Y-directions. In a set of pixels CGh, the first pixel number is 2, and the second pixel number is 4.

The length in the X-direction of the sides on the −Y side and the +Y side of a set of pixels CGh is equal to that of a set of sub-pixels CSh. The length in the Y-direction of a set of pixels CGh is equal to that of a set of sub-pixels CSh.

A plurality of sets of pixels CGh are arrayed such that the side on the −Y side of a set of pixels CGh matches the side on the −Y side of a set of sub-pixels CSh. By disposing a set of pixels CGh in this manner, a plurality of sets of pixels CGh do not overlap each other and are arrayed along the first direction D1 and the second direction D2 with no space interposed therebetween in the display region DA. The set of pixels CGh corresponding to a set of sub-pixels CSh is a set of pixels CGh having the side on the −Y side that matches the side on the −Y side of the set of sub-pixels CSh.

A plurality of sub-pixels S are arrayed along the second direction D2 as described above, so the signal lines Lb also extend along the second direction D2. In other words, the signal lines Lb according to the second modification are disposed in a manner inclined with respect to the X- and Y-directions. As a result, the signal lines Lb according to the second modification are disposed also on the +X side and the −X side of the display region DA.

By contrast, the signal lines Lb according to the first embodiment extend along the Y-direction as illustrated in FIG. 2 and are not disposed on the +X side or the −X side of the display region DA unlike the signal lines Lb according to the second modification. Therefore, the number of signal lines Lb according to the second modification is larger than the number of signal lines Lb according to the first embodiment. The same applies to a case where the array of the sub-pixels S is the SQy pixel array and the stripe pixel array for comparison.

In the generation of the sub-gradation data using Expression (1), the X-coordinate of the sub-pixel S is calculated by Expression (19) instead of Expression (5). In Expression (19), “v₀” is a value indicating the display row number of the sub-pixel S serving as a reference and is 1, for example.

$${x}_{p} = \frac{u - 0.5}{{k}_{x}} + \frac{( v - {v}_{0} ) tan ( {θ}_{g} )}{{k}_{y}} \qquad ( 19 )$$

In the generation of the sub-gradation data using Expression (9), N in Expression (12) is calculated by Expressions (20) and (21).

$$N = floor ( ( v - 1 ) / FIRST SUB - PIXEL NUMBER ) + 1 + floor ( ( M - 1 + du 0 - 1 ) / FIRST SUB - PIXEL NUMBER ) \qquad ( 20 )$$

$$du 0 = mod ( u - 1 , FIRST SUB - PIXEL NUMBER ) + 1 \qquad ( 21 )$$

Thus, the display device 1 according to the second modification can achieve high resolution and a relatively high refresh rate as in the first embodiment if the second direction D2 is inclined with respect to the X- and Y-directions.

### Third Modification of the Second Embodiment

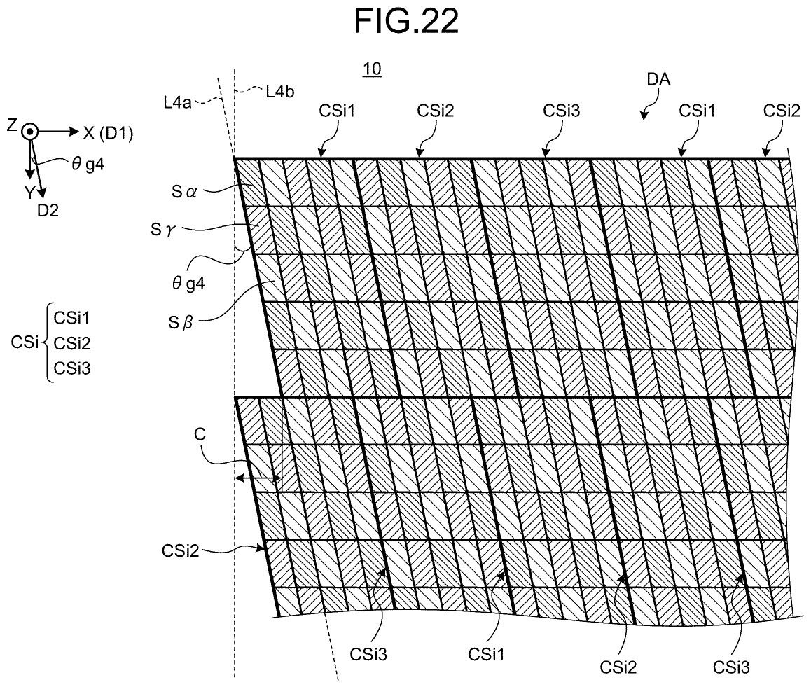

The following describes a third modification of the second embodiment focusing mainly on the differences from the second modification of the second embodiment. FIG. 22 is a plan view of the display panel 10 indicating the array of a plurality of sets of sub-pixels CSi according to the third modification of the second embodiment of the present disclosure.

In the display device 1 according to the third modification, the magnitude of the inclination angle is different from that according to the second modification of the second embodiment described above. The second direction D2 is parallel to a dashed line L4a having an inclination angle θg4 with respect to a dashed line L4b parallel to the Y-direction in plan view. As in the second modification of the second embodiment, the first direction D1 is parallel to the X-direction, and the Y-direction corresponds to the “third direction”.

The inclination angle θg4 is defined as an angle where tan θg4=A×(First Pixel Number/(Second Pixel Number x First Sub-Pixel Number)) is satisfied (“A” is a natural number or the reciprocal of a natural number). FIG. 22 illustrates a case where A=2 is satisfied. When A=2 is satisfied, and the first pixel number is “2”, the second pixel number is “4”, and the first sub-pixel number is “5” as in the first embodiment, tan θg4=1/5 and the inclination angle θg4=11.3° are satisfied.

As in the second embodiment, the sub-pixels S are arrayed in a matrix (row-column configuration) along the first direction D1 and the second direction D2, and the array of the sub-pixels S is the SQy1 array.

In the display region DA, a plurality of sets of sub-pixels CSi are arrayed along the first direction D1 and the second direction D2. In a set of sub-pixels CSi, the first sub-pixel number is 5, and the second sub-pixel number is 5 as in the first embodiment.

By defining the inclination angle θg4 as described above, a plurality of sets of pixels CGi corresponding to a plurality of sets of sub-pixels CSi do not overlap each other and are arrayed along the first direction D1 and the second direction D2 with no space interposed therebetween in the display region DA as described below. In two sets of sub-pixels CSi adjacent to each other in the second direction D2, the distance C in the X-direction between the sub-pixels S corresponding to the same set row number out of the sub-pixels S arrayed in the same column along the second direction D2 is A×(First Pixel Number/First Sub-Pixel Number) times the length of the pixel G in the X-direction (=1).

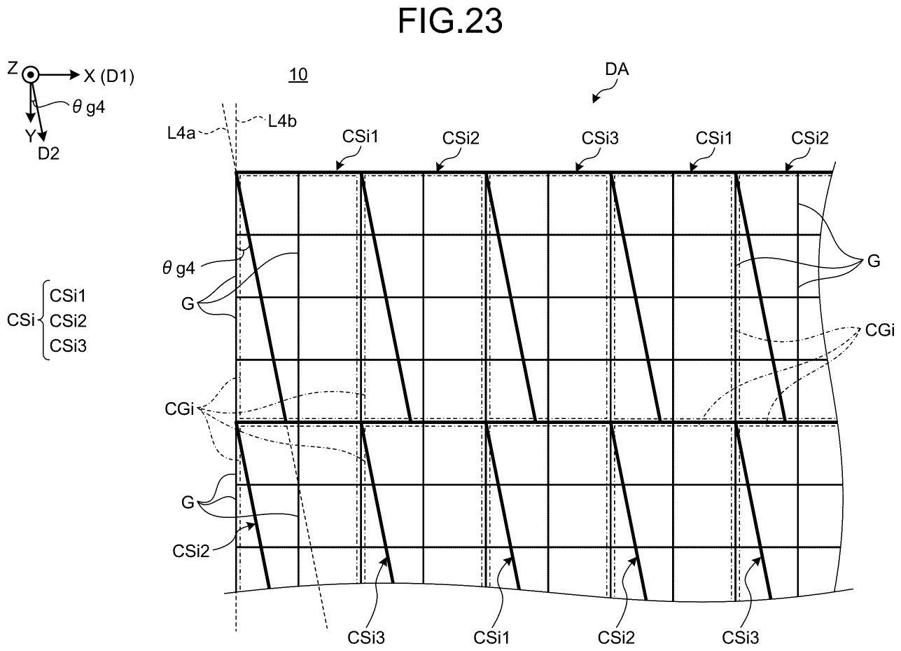

FIG. 23 is a diagram of the positional relation between a plurality of sets of sub-pixels CSi and a plurality of sets of pixels CGi according to the third modification of the second embodiment of the present disclosure. As in the second embodiment, a plurality of pixels G are arrayed in a matrix (row-column configuration) along the X- and Y-directions. In a set of pixels CGi, the first pixel number is 2, and the second pixel number is 4.

The length in the X-direction of the sides on the −Y side and the +Y side of a set of pixels CGi is equal to that of a set of sub-pixels CSi. The length in the Y-direction of a set of pixels CGi is equal to that of a set of sub-pixels CSi.

A plurality of sets of pixels CGi are arrayed such that the side on the −Y side of a set of pixels CGi matches the side on the −Y side of a set of sub-pixels CSi. By disposing a set of pixels CGi in this manner, a plurality of sets of pixels CGi do not overlap each other and are arrayed along the first direction D1 and the second direction D2 with no space interposed therebetween in the display region DA. The set of pixels CGi corresponding to a set of sub-pixels CSi is a set of pixels CGi having the side on the −Y side that matches the side on the −Y side of the set of sub-pixels CSi.

The display device 1 according to the third modification can achieve high resolution and a relatively high refresh rate as in the second modification of the second embodiment.

While the exemplary embodiments of the present disclosure have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure.

For example, the display panel 10 may be a vertical electric field liquid crystal display in which the common electrodes CE are disposed on the second substrate 14 to face the sub-pixel electrodes PE. Alternatively, the display panel 10 may be a reflective liquid crystal display.

The array of the first sub-pixels Sα, the second sub-pixels Sβ, and the third sub-pixels Sγ in the display region DA may be a Delta2 array. Specifically, in the Delta2 array, the first sub-pixel Sα, the second sub-pixel Sβ, and the third sub-pixel Sγ are repeatedly disposed in this order along the X-direction. The first sub-pixel Sa and the third sub-pixel Sγ are alternately arrayed along the Y-direction in a first column, the second sub-pixel SB and the first sub-pixel Sa are alternately arrayed along the Y-direction in a second column, and the third sub-pixel Sγ and the second sub-pixel SB are alternately arrayed along the Y-direction in a third column. The first column, the second column, and the third column are repeatedly disposed in this order along the X-direction. The array of the first sub-pixels Sα, the second sub-pixels Sβ, and the third sub-pixels Sγ in the display region DA is not limited to the SQy1 array or the Delta2 array described above.

Out of other advantageous effects achieved by the aspects described in the present embodiment, advantageous effects clearly defined by the description in the present specification or appropriately conceivable by those skilled in the art are naturally achieved by the present disclosure.

What is claimed is:

1. A display device comprising:
a plurality of sub-pixels arrayed in a matrix along a first direction and a second direction orthogonal to each other in a display region for displaying an image; and
a drive circuit configured to drive the sub-pixels based on pixel data having information on a plurality of pixels constituting the image, wherein
the sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction,
the pixels are positioned in a matrix along the first direction and the second direction,
each of the sets of sub-pixels corresponds to a set of pixels in which the pixels are arrayed in a matrix with the pixels of a first pixel number of 2 or larger arranged along the first direction and the pixels of a second pixel number of 2 or larger arranged along the second direction,
a value obtained by dividing the second sub-pixel number by the second pixel number is larger than 1 and smaller than 1.5, and
the drive circuit is configured to drive each of the sub-pixels based on the pixel data of the pixels in a predetermined region.

2. The display device according to claim 1, wherein
a value obtained by dividing the first sub-pixel number by the first pixel number is larger than 2 and smaller than 3.

3. The display device according to claim 1, wherein
the sub-pixels include a first sub-pixel, a second sub-pixel, and a third sub-pixel,
the pixel data includes first pixel data corresponding to the first sub-pixel, second pixel data corresponding to the second sub-pixel, and third pixel data corresponding to the third sub-pixel, and
the first sub-pixel number, the second sub-pixel number, the first pixel number, and the second pixel number are defined such that a ratio of a total of numbers of the first pixel data, the second pixel data, and the third pixel data of the pixels constituting each of the sets of pixel to a total of numbers of the first sub-pixels, the second sub-pixels, and the third sub-pixels included in each of the sets of sub-pixels is 0.9 to 1.1.

4. The display device according to claim 1, wherein the sets of sub-pixels are arrayed along the first direction and the second direction.

5. The display device according to claim 1, wherein the predetermined region is defined based on a distance between the sub-pixel and the pixel.

6. The display device according to claim 1, wherein a periphery of each of the sets of sub-pixels overlaps a periphery of a corresponding one of the sets of pixels.

7. The display device according to claim 1, wherein
the sub-pixels include a first sub-pixel, a second sub-pixel, and a third sub-pixel, and
a plurality of the first sub-pixels, a plurality of the second sub-pixels, and a plurality of the third sub-pixels are disposed such that the first sub-pixel, the second sub-pixel, and the third sub-pixel are repeatedly disposed in the order as listed along the first direction and the first sub-pixel, the third sub-pixel, and the second sub-pixel are repeatedly disposed in the order as listed along the second direction.

8. The display device according to claim 7, wherein
the first sub-pixel is a red sub-pixel,
the second sub-pixel is a green sub-pixel, and
the third sub-pixel is a blue sub-pixel.

9. A display device comprising:
a plurality of sub-pixels arrayed in a matrix along a first direction and a second direction inclined with respect to the first direction in a display region for displaying an image; and
a drive circuit configured to drive the sub-pixels based on pixel data having information on a plurality of pixels constituting the image, wherein
the sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction,
the pixels are positioned in a matrix along the second direction and a third direction orthogonal to the second direction,
each of the sets of sub-pixels corresponds to a set of pixels in which the pixels are arrayed in a matrix with the pixels of a first pixel number of 2 or larger arranged along the third direction and the pixels of a second pixel number of 2 or larger arranged along the second direction,
a value obtained by dividing the second sub-pixel number by the second pixel number is larger than 1 and smaller than 1.5, and
the drive circuit is configured to drive each of the sub-pixels based on the pixel data of the pixels in a predetermined region.

10. A display device comprising:
a plurality of sub-pixels arrayed in a matrix along a first direction and a second direction inclined with respect to the first direction in a display region for displaying an image; and
a drive circuit configured to drive the sub-pixels based on pixel data having information on a plurality of pixels constituting the image, wherein
the sub-pixels constitute a plurality of sets of sub-pixels in each of which the sub-pixels are arrayed in a matrix with the sub-pixels of a first sub-pixel number of 2 or larger arranged along the first direction and the sub-pixels of a second sub-pixel number of 2 or larger arranged along the second direction,
the pixels are positioned in a matrix along the first direction and a third direction orthogonal to the first direction,
each of the sets of sub-pixels corresponds to a set of pixels in which the pixels are arrayed in a matrix with the pixels of a first pixel number of 2 or larger arranged along the first direction and the pixels of a second pixel number of 2 or larger arranged along the third direction,
a value obtained by dividing the second sub-pixel number by the second pixel number is larger than 1 and smaller than 1.5, and
the drive circuit drives the sub-pixels based on the pixel data of the pixels in a predetermined region.
